(19) United States
(12) Patent Application Publication
(10) Pub. No.: US 2014/0279148 A1
(43) Pub. Date: Sep. 18, 2014

(54) ACQUIRING OPEN BIDS FOR ONE OR MORE CONTENT ACCESS LATENCIES AND PROVIDING CONTENT ACCORDINGLY

(71) Applicant: Elwha LLC, Bellevue, WA (US)

(72) Inventors: Roderick A. Hyde, Redmond, WA (US); Royce A. Levien, Lexington, MA (US); Richard T. Lord, Tacoma, WA (US); Robert W. Lord, Seattle, WA (US); Mark A. Malamud, Seattle, WA (US); Tony S. Pan, Cambridge, MA (US); Lowell L. Wood, JR., Bellevue, WA (US)

(21) Appl. No.: 13/930,431

(22) Filed: Jun. 28, 2013

Related U.S. Application Data
(63) Continuation of application No. 13/928,859, filed on Jun. 27, 2013.
Application No. 13/928,859 is a continuation-in-part of application No. 13/795,612, filed on Mar. 12, 2013.
Application No. 13/795,612 is a continuation-in-part of application No. 13/854,203, filed on Apr. 1, 2013.
Application No. 13/854,203 is a continuation of application No. 13/853,706, filed on Mar. 29, 2013.
Application No. 13/928,859 is a continuation-in-part of application No. 13/859,061, filed on Apr. 9, 2013.
Application No. 13/859,061 is a continuation of application No. 13/858,656, filed on Apr. 8, 2013.
Application No. 13/928,859 is a continuation-in-part of application No. 13/868,335, filed on Apr. 23, 2013.
Application No. 13/868,335 is a continuation of application No. 13/867,313, filed on Apr. 22, 2013.
Application No. 13/928,859 is a continuation-in-part of application No. 13/894,625, filed on May 15, 2013.
Application No. 13/894,625 is a continuation of application No. 13/893,879, filed on May 14, 2013.
Application No. 13/928,859 is a continuation-in-part of application No. 13/906,633, filed on May 31, 2013.
Application No. 13/906,633 is a continuation of application No. 13/905,839, filed on May 30, 2013.

(51) Int. Cl. G06Q 30/08

(52) U.S. Cl. CPC G06Q 30/08
USPC 705/26.3

(57) ABSTRACT

Computationally implemented methods and systems include acquiring from a plurality of users a plurality of open bids for one or more content access latencies, each of the plurality of open bids to be received indicating one or more offer amounts submitted by the plurality of users that the plurality of users are offering in exchange for being provided at least access to a specific content with the one or more content access latencies; determining which one or more of the plurality of open bids indicate at least the highest offer amount amongst the plurality of open bids; and providing at least access to the specific content to one or more of the plurality of users in accordance, at least in part, with the determining. In addition to the foregoing, other aspects are described in the claims, drawings, and text.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority application(s)). In addition, the present application is related to the “Related applications,” if any, listed below.

### PRIORITY APPLICATIONS

The present application constitutes a continuation-in-part of U.S. patent application Ser. No. 13/795,612, entitled TIERED LATENCY OF ACCESS FOR CONTENT, naming Roderick A. Hyde; Royce A. Levien; Richard T. Lord; Robert W. Lord; Mark A. Malamud; Tony S. Pan; Lowell L. Wood, Jr. as inventors, filed 12, Mar., 2013 with attorney docket no. 0912-003-001-000000, which is currently co-pending or is an application of which a currently co-pending application is entitled to the benefit of the filing date.

The present application constitutes a continuation-in-part of U.S. patent application Ser. No. 13/854,203, entitled PROVIDING ACCESS TO CONTENT IN ACCORDANCE WITH A SELECTED LEVEL OF ACCESS FROM A PLURALITY OF GRADUATED LEVELS OF ACCESS, naming Roderick A. Hyde; Royce A. Levien; Richard T. Lord; Robert W. Lord; Mark A. Malamud; Tony S. Pan; Lowell L. Wood, Jr. as inventors, filed 1, Apr., 2013 with attorney docket no. 0912-003-002-000001, which is currently co-pending or is an application of which a currently co-pending application is entitled to the benefit of the filing date, and which is a continuation of U.S. patent application Ser. No. 13/853,706, entitled PROVIDING ACCESS TO CONTENT IN ACCORDANCE WITH A SELECTED LEVEL OF ACCESS FROM A PLURALITY OF GRADUATED LEVELS OF ACCESS, naming Roderick A. Hyde; Royce A. Levien; Richard T. Lord; Robert W. Lord; Mark A. Malamud; Tony S. Pan; Lowell L. Wood, Jr. as inventors, filed 29, Mar., 2013 with attorney docket no. 0912-003-002-000000.

The present application constitutes a continuation-in-part of U.S. patent application Ser. No. 13/859,061, entitled RECEIVING CONTENT IN ACCORDANCE WITH A PARTICULAR LEVEL OF ACCESS ASSOCIATED WITH A PARTICULAR AMOUNT OF CONTENT ACCESS LATENCY, naming Roderick A. Hyde; Royce A. Levien; Richard T. Lord; Robert W. Lord; Mark A. Malamud; Tony S. Pan; Lowell L. Wood, Jr. as inventors, filed 9, Apr., 2013 with attorney docket no. 0912-003-003-C00001, which is currently co-pending or is an application of which a currently co-pending application is entitled to the benefit of the filing date, and which is a continuation of U.S. patent application Ser. No. 13/858,656, entitled RECEIVING CONTENT IN ACCORDANCE WITH A PARTICULAR LEVEL OF ACCESS ASSOCIATED WITH A PARTICULAR AMOUNT OF CONTENT ACCESS LATENCY, naming Roderick A. Hyde; Royce A. Levien; Richard T. Lord; Robert W. Lord; Mark A. Malamud; Tony S. Pan; Lowell L. Wood, Jr. as inventors, filed 8, Apr., 2013 with attorney docket no. 0912-003-003-000000.

The present application constitutes a continuation-in-part of U.S. patent application Ser. No. 13/868,335, entitled TRANSMITTING CONTENT IN ACCORDANCE WITH A PARTICULAR LEVEL OF REQUESTED ACCESS ASSOCIATED WITH A PARTICULAR AMOUNT OF CONTENT ACCESS LATENCY, naming Roderick A. Hyde; Royce A. Levien; Richard T. Lord; Robert W. Lord; Mark A. Malamud; Tony S. Pan; Lowell L. Wood, Jr. as inventors, filed 23, Apr., 2013 with attorney docket no. 0912-003-008-000000, which is currently co-pending or is an application of which a currently co-pending application is entitled to the benefit of the filing date, and which is a continuation of U.S. patent application Ser. No. 13/867,313, entitled TRANSMITTING CONTENT IN ACCORDANCE WITH A PARTICULAR LEVEL OF REQUESTED ACCESS ASSOCIATED WITH A PARTICULAR AMOUNT OF CONTENT ACCESS LATENCY, naming Roderick A. Hyde; Royce A. Levien; Richard T. Lord; Robert W. Lord; Mark A. Malamud; Tony S. Pan; Lowell L. Wood, Jr. as inventors, filed 22 Apr., 2013 with attorney docket no. 0912-003-004-000000.

The present application constitutes a continuation-in-part of U.S. patent application Ser. No. 13/894,625, entitled ELICITING ONE OR MORE BIDS FOR ACCESSING CONTENT AT ONE OR MORE LEVELS OF CONTENT ACCESS FROM TWO OR MORE CLIENT COMPUTING DEVICES, naming Roderick A. Hyde; Royce A. Levien; Richard T. Lord; Robert W. Lord; Mark A. Malamud; Tony S. Pan; Lowell L. Wood, Jr. as inventors, filed 15, May, 2013 with attorney docket no. 0912-003-009-000000, which is currently co-pending or is an application of which a currently co-pending application is entitled to the benefit of the filing date, and which is a continuation of U.S. patent application Ser. No. 13/893,879, entitled ELICITING ONE OR MORE BIDS FOR ACCESSING CONTENT AT ONE OR MORE LEVELS OF CONTENT ACCESS FROM TWO OR MORE CLIENT COMPUTING DEVICES, naming Roderick A. Hyde; Royce A. Levien; Richard T. Lord; Robert W. Lord; Mark A. Malamud; Tony S. Pan; Lowell L. Wood, Jr. as inventors, filed 14, May, 2013 with attorney docket no. 0912-003-005-000000.

The present application constitutes a continuation-in-part of U.S. patent application Ser. No. 13/906,633, entitled PRESENTING CONTENT AS A RESULT, AT LEAST IN PART, TO RELAYING OF A BID AND FOLLOWING LAPSE OF A SPECIFIC AMOUNT OF CONTENT ACCESS LATENCY, naming Roderick A. Hyde; Royce A. Levien; Richard T. Lord; Robert W. Lord; Mark A. Malamud; Tony S. Pan; Lowell L. Wood, Jr. as inventors, filed 31, May, 2013 with attorney docket no. 0912-003-010-000000, which is currently co-pending or is an application of which a currently co-pending application is entitled to the benefit of the filing date, and which is a continuation of U.S. patent application Ser. No. 13/905,839, entitled PRESENTING CONTENT AS A RESULT, AT LEAST IN PART, TO RELAYING OF A BID AND FOLLOWING LAPSE OF A SPECIFIC AMOUNT OF CONTENT ACCESS LATENCY, naming Roderick A. Hyde; Royce A. Levien; Richard T. Lord; Robert W. Lord; Mark A. Malamud; Tony S. Pan; Lowell L. Wood, Jr. as inventors, filed 30, May, 2013 with attorney docket no. 0912-003-006-000000.

### RELATED APPLICATIONS

None

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s). If the listings of applications provided above are inconsistent with the listings provided via an ADS, it is the intent of the Applicant to claim priority to each application that appears in the Priority applications section of the ADS and to each application that appears in the Priority applications section of this application. All subject matter of the Priority applications and the Related applications and of any and all parent, grandparent, great-grandparent, etc. applications of the Priority applications and the Related applications, including any priority claims, is incorporated herein by reference to the extent such subject matter is not inconsistent herewith.

Under the auspices of various alleged “rules” implementing the America Invents Act (AIA), the United States Patent and Trademark Office (USPTO) is purporting to require that an Attorney for a Client make various legal and/or factual statements/commentaries/admissions (e.g. Concerning any “Statement under 37 CFR 1.55 or 1.78 for AIA (First Inventor to File) Transition Application”) related to written description/new matter, and/or advise his Client to make such legal and/or factual statements/commentaries/admissions. Attorney expressly points out that the burden of both alleging that an application contains new matter with respect to its parent(s) and establishing a prima facie case of lack of written description under 35 U.S.C. §112, first paragraph lies firmly on the USPTO. Accordingly, and expressly in view of duties owed his client, Attorney further points out that the AIA legislation, while referencing the first to file, does not appear to constitute enabling legislation that would empower the USPTO to compel an Attorney to either make/advise such legal and/or factual statements/commentaries/admissions. Notwithstanding the foregoing, Attorney/Applicant understand that the USPTO's computer programs/personnel have certain data entry requirements, and hence Attorney/Applicant have provided a designation(s) of a relationship between the present application and its parent application(s) as set forth herein and in any ADS filed in this application, but expressly points out that such designation(s) are not to be construed in any way as any type of commentary and/or admission as to whether or not a claim in the present application is supported by a parent application, or whether or not the present application contains any new matter in addition to the matter of its parent application(s) in general and/or especially as such might relate to an effective filing date before, on, or after 16 Mar. 2013.

Insofar that the Attorney/Applicant may have made certain statements in view of practical data entry requirements of the USPTO should NOT be taken as an admission of any sort. Attorney/Applicant hereby reserves any and all rights to contest/contradict/confirm such statements at a later time. Furthermore, no waiver (legal, factual, or otherwise), implicit or explicit, is hereby intended (e.g., with respect to any statements/admissions made by the Attorney/Applicant in response to the purported requirements of the USPTO related to the relationship between the present application and parent application[s], and/or regarding new matter or alleged new matter relative to the parent application[s]). For example, although not expressly stated and possibly despite a designation of the present application as a continuation-in-part of a parent application, Attorney/Applicant may later assert that the present application or one or more of its claims do not contain any new matter in addition to the matter of its parent application[s], or vice versa.

### SUMMARY

In one or more various aspects, a method includes but is not limited to acquiring from a plurality of users a plurality of open bids for one or more content access latencies, each of the plurality of open bids to be received indicating one or more offer amounts submitted by the plurality of users that the plurality of users are offering in exchange for being provided at least access to a specific content with the one or more content access latencies; determining which one or more of the plurality of open bids indicate at least the highest offer amount amongst the plurality of open bids; and providing at least access to the specific content to one or more of the plurality of users in accordance, at least in part, with the determining. In some implementations, at least one of the registering, detecting, or displaying being performed by a machine or article of manufacture. In addition to the foregoing, other method aspects are described in the claims, drawings, and text forming a part of the disclosure set forth herein.

In one or more various aspects, one or more related systems may be implemented in machines, compositions of matter, or manufactures of systems, limited to patentable subject matter under 35 U.S.C. 101. The one or more related systems may include, but are not limited to, circuitry and/or programming for effecting the herein-referenced method aspects. The circuitry and/or programming may be virtually any combination of hardware, software, and/or firmware configured to effect the herein-referenced method aspects depending upon the design choices of the system designer, and limited to patentable subject matter under 35 USC 101.

In one or more various aspects, a system includes, but is not limited to, means for acquiring from a plurality of users a plurality of open bids for one or more content access latencies, each of the plurality of open bids to be received indicating one or more offer amounts submitted by the plurality of users that the plurality of users are offering in exchange for being provided at least access to a specific content with the one or more content access latencies, means for determining which one or more of the plurality of open bids indicate at least the highest offer amount amongst the plurality of open bids, and means for providing at least access to the specific content to one or more of the plurality of users in accordance, at least in part, with the determining. In addition to the foregoing, other system aspects are described in the claims, drawings, and text forming a part of the disclosure set forth herein.

In one or more various aspects, a system includes, but is not limited to, circuitry for acquiring from a plurality of users a plurality of open bids for one or more content access latencies, each of the plurality of open bids to be received indicating one or more offer amounts submitted by the plurality of users that the plurality of users are offering in exchange for being provided at least access to a specific content with the one or more content access latencies, circuitry for determining which one or more of the plurality of open bids indicate at least the highest offer amount amongst the plurality of open bids, and circuitry for providing at least access to the specific content to one or more of the plurality of users in accordance, at least in part, with the determining. In addition to the foregoing, other system aspects are described in the claims, drawings, and text forming a part of the disclosure set forth herein.

In one or more various aspects, a computer program product, comprising a signal bearing non-transitory storage medium, bearing one or more instructions including, but not limited to, acquiring from a plurality of users a plurality of open bids for one or more content access latencies, each of the plurality of open bids to be received indicating one or more offer amounts submitted by the plurality of users that the plurality of users are offering in exchange for being provided at least access to a specific content with the one or more content access latencies, determining which one or more of the plurality of open bids indicate at least the highest offer amount amongst the plurality of open bids, and providing at least access to the specific content to one or more of the plurality of users in accordance, at least in part, with the determining. In addition to the foregoing, other computer program product aspects are described in the claims, drawings, and text forming a part of the disclosure set forth herein.

In one or more various aspects, a system includes, but is not limited to an open bid obtaining module configured to obtain a plurality of open bids for one or more content access latencies, each of the plurality of open bids to be obtained indicating one or more offer amounts submitted by a plurality of users that the plurality of users are offering in exchange for being provided at least access to a specific content with the one or more content access latencies; a highest offer amount open bid ascertaining module configured to ascertain which one or more of the plurality of open bids indicate at least the highest offer amount amongst the plurality of open bids; and a content access releasing module configured to release at least access to the specific content to one or more of the plurality of users in accordance, at least in part, with the ascertaining which of the one or more of the plurality of open bids indicate at least the highest offer amount amongst the plurality of open bids.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail. Consequently, those skilled in the art will appreciate that the summary is illustrative only and is NOT intended to be in any way limiting. Other aspects, features, and advantages of the devices and/or processes and/or other subject matter described herein will become apparent by reference to the detailed description, the corresponding drawings, and/or in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise. The illustrative embodiments described in the detailed description, drawings, and claims are not meant to be limiting. Other embodiments may be utilized, and other changes may be made, without departing from the spirit or scope of the subject matter presented here.

FIG. 1 shows a high-level block diagram of a computing system 10* operating in a network environment.

FIGS. 2A, 2B, 2C, 2D, 2E, 2F, 2G, 2H, 2I, 2K, and 2M show exemplary graphical user interfaces (GUIs) that may be displayed by one or more of the client devices 60a, 60b, 60c, and 60d of FIG. 1.

FIG. 3A shows a block diagram of particular implementation of the computing system 10* of FIG. 1.

FIG. 3B shows a block diagram of another implementation of the computing system 10* of FIG. 1

FIG. 4A shows another perspective of the open bid obtaining module 102* of FIGS. 3A and 3B (e.g., the open bid obtaining module 102′ of FIG. 3A or the open bid obtaining module 102″ of FIG. 3B) in accordance with various implementations.

FIG. 4B shows another perspective of the highest offer amount open bid ascertaining module 104* of FIGS. 3A and 3B (e.g., the highest offer amount open bid ascertaining module 104′ of FIG. 3A or highest offer amount open bid ascertaining module 104″ of FIG. 3B) in accordance with various implementations.

FIG. 4C shows another perspective of the content access releasing module 106* of FIGS. 3A and 3B (e.g., the content access releasing module 106′ of FIG. 3A or the content access releasing module 106″ of FIG. 3B) in accordance with various implementations.

FIG. 5 is a high-level logic flowchart of a process, e.g., operational flow 500, according to some embodiments.

FIG. 6A is a high-level logic flowchart of a process depicting alternate implementations of the open bid acquiring operation 502 of FIG. 5.

FIG. 6B is a high-level logic flowchart of a process depicting alternate implementations of the open bid acquiring operation 502 of FIG. 5.

FIG. 6C is a high-level logic flowchart of a process depicting alternate implementations of the open bid acquiring operation 502 of FIG. 5.

FIG. 6D is a high-level logic flowchart of a process depicting alternate implementations of the open bid acquiring operation 502 of FIG. 5.

FIG. 6E is a high-level logic flowchart of a process depicting alternate implementations of the open bid acquiring operation 502 of FIG. 5.

FIG. 6F is a high-level logic flowchart of a process depicting alternate implementations of the open bid acquiring operation 502 of FIG. 5.

FIG. 6G is a high-level logic flowchart of a process depicting alternate implementations of the open bid acquiring operation 502 of FIG. 5.

FIG. 6H is a high-level logic flowchart of a process depicting alternate implementations of the open bid acquiring operation 502 of FIG. 5.

FIG. 6I is a high-level logic flowchart of a process depicting alternate implementations of the open bid acquiring operation 502 of FIG. 5.

FIG. 6J is a high-level logic flowchart of a process depicting alternate implementations of the open bid acquiring operation 502 of FIG. 5.

FIG. 6K is a high-level logic flowchart of a process depicting alternate implementations of the open bid acquiring operation 502 of FIG. 5.

FIG. 6L is a high-level logic flowchart of a process depicting alternate implementations of the open bid acquiring operation 502 of FIG. 5.

FIG. 6M is a high-level logic flowchart of a process depicting alternate implementations of the open bid acquiring operation 502 of FIG. 5.

FIG. 6N is a high-level logic flowchart of a process depicting alternate implementations of the open bid acquiring operation 502 of FIG. 5.

FIG. 6P is a high-level logic flowchart of a process depicting alternate implementations of the open bid acquiring operation 502 of FIG. 5.

FIG. 6Q is a high-level logic flowchart of a process depicting alternate implementations of the open bid acquiring operation 502 of FIG. 5.

FIG. 7A is a high-level logic flowchart of a process depicting alternate implementations of the highest offer amount open bid determining operation 504 of FIG. 5.

FIG. 7B is a high-level logic flowchart of a process depicting alternate implementations of the highest offer amount open bid determining operation 504 of FIG. 5.

FIG. 8A is a high-level logic flowchart of a process depicting alternate implementations of the content access providing operation 506 of FIG. 5.

FIG. 8B is a high-level logic flowchart of a process depicting alternate implementations of the content access providing operation 506 of FIG. 5.

FIG. 8C is a high-level logic flowchart of a process depicting alternate implementations of the content access providing operation 506 of FIG. 5.

FIG. 8D is a high-level logic flowchart of a process depicting alternate implementations of the content access providing operation 506 of FIG. 5.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

Throughout this application, examples and lists are given, with parentheses, the abbreviation “e.g.,” or both. Unless explicitly otherwise stated, these examples and lists are merely exemplary and are non-exhaustive. In most cases, it would be prohibitive to list every example and every combination. Thus, smaller, illustrative lists and examples are used, with focus on imparting understanding of the claim terms rather than limiting the scope of such terms.

In recent years, the rapid development of computing and networking technologies has fueled explosive growth in demand for content. The word “content” for purposes of this description may be in reference to any one or more of a wide variety of data/information that may be made available through today's computing and/or networking technologies. Some examples of content include news (e.g., business or financial news such as stock or commodities prices, celebrity news, regulatory news, agricultural news, sports news, and so forth), information provided through social media, consumable media such as movies, soundtracks, recordings of sporting events or concerts, and so forth.

As these technologies continue to evolve, actual and potential consumers of such content (hereinafter “content consumers” or simply “users”) are also demanding earlier and more timely access to content. For example, content consumers from the financial or commodity industries are demanding increasingly earlier and earlier access to content (e.g., financial or market data such as stock or commodity prices). That is, early knowledge of certain financial/market/commodity information by, for example, institutional content consumers (e.g., banks, brokerage firms, etc.) may provide huge advantages for those institutional content consumers. Similarly, many everyday consumers of consumable media (e.g., movies, sports program, audio recordings, etc.) have a strong desire to access such consumable media as soon as such media becomes available.

It is also recognized that while some content consumers are willing to pay a large premium for early access to content, other content consumers may not be as willing to pay such a high premium for early access to the same content. It is further recognized that different content consumers will have different needs as to how soon they would like to access content and how much of a premium they would be willing to pay in order to get such content access. Accordingly, computationally-implemented systems and methods are provided herein that allow multiple content consumers (e.g., users) to submit multiple bids for earlier access to a particular content in exchange for higher early access fees. Based, at least in part, on the submitted bids, one or more of the multiple content consumers may be provided at least early access to the particular content (e.g., access to the particular content with minimal content access latency).

More particularly, the computationally-implemented systems and methods, in various embodiments, may be designed to obtain or acquire a plurality of open bids for one or more content access latencies, each of the plurality of open bids to be received indicating one or more offer amounts submitted by a plurality of users that the plurality of users are offering in exchange for being provided at least access to a specific content with the one or more content access latencies. The computationally-implemented systems and methods may then be designed to determine or ascertain which one or more of the plurality of open bids indicate at least the highest offer amount amongst the plurality of open bids, and to provide or release at least access to the specific content to one or more of the plurality of users in accordance, at least in part, with the determining or ascertaining which of the one or more of the plurality of open bids indicate at least the highest offer amount amongst the plurality of open bids. In various embodiments, an “open bid” is an offer that may be made (e.g., submitted) by a user for a specific content access latency and that is an offer in which a user gets to decide (e.g., is allowed to choose) how much to offer, for example, for a particular content access latency. In contrast, a “closed” or “fixed” bid is a bid that includes a fixed offer amount (not modifiable by a user) that may have been set by, for example, a content source or provider.

In some embodiments, the open bids that may be submitted by different users may be for different content access latencies. For example, different users may specify different content access latencies that they wish to bid for and/or the content provider may specify that different content access latencies may be available for bidding. Alternatively, the open bids that may be submitted by users may be for unspecified content access latencies. In such situations, the highest bidders (e.g., users who submit the highest open bids indicating the highest offer amounts) may be provided access to the content with the smallest amount of latency (e.g., content access latency), or different levels of content access latencies may be granted to different users based on how big their open bids are with respect to the other open bids from other users.

Turning now to FIG. 1, which illustrates an example environment 100 in which the methods, systems, circuitry, and computer program products in accordance with various embodiments may be implemented at a computing system 10*. In some embodiments, the computing system 10* may be a network device such as a server. In some alternative embodiments, however, the computing system 10* may be a plurality of network devices such as a plurality of network computers, servers, and storage devices. Note that FIGS. 3A and 3B illustrate block diagrams of two alternative implementations of the computing system 10* of FIG. 1. Note further that in the following, “*” represents a wildcard. Thus, references in the following description to, for example, “computing system 10*” may be in reference to the computing system 10′ of FIG. 3A or the computing system 10″ of FIG. 3B (as well as to the computing system 10* of FIG. 1). Similarly, reference to a “user 62*” may be in reference to user 62a, user 62b, user 62c, or user 62d of FIG. 1.

In various embodiments, the computing system 10* may electronically communicate with a plurality of client devices 60* (e.g., client devices 60a, 60b, 60c, and 60d of FIG. 1) via one or more wireless and/or wired networks 5. Note that for ease of explanation and illustration, only four client devices 60a, 60b, 60c, and 60d are illustrated in FIG. 1. Thus, although only four client devices 60* are actually depicted in FIG. 1, in alternative implementations, fewer or greater number of client devices 60* may be in communication with the computing system 10* of FIG. 1. In various embodiments, each of the client devices 60* (e.g., client device 60a, 60b, 60c, or 60d) illustrated in FIG. 1 may be associated with a corresponding user 62* (e.g., user 62a, 62b, 62c, or 62d). For example, client device 60a being associated with at least user 62a, client device 60b being associated with at least user 62b, and so forth. In some cases, a particular user 62*, such as user 62a, may be associated with a particular client device 60*, such as client device 60a, when the user 62a has log-in and/or personal access to the client device 60a. In some cases, multiple users 62* may be associated with a single client device 60* (e.g., multiple users 62* may have accessing rights to a particular client device 60*). In some cases, a user 62* may be a person or persons while in other cases, a user 62* may be an organization such as a business entity. In various embodiments, a client device 60* may be a general purpose computing device such as a desktop computer, a workstation, a laptop computer, a tablet computer, a Smartphone, or a PDA (personal digital assistant, and so forth). Alternatively, a client device 60* may be a dedicated or specialized system such as an electronic trading platform (e.g., Bloomberg terminal). In various embodiments, each of the client devices 60* may also be able to communicate with the other client devices 60*.

The one or more wireless and/or wired networks 5 illustrated in FIG. 1 may include, for example, a local area network (LAN), a wireless local area network (WLAN), a personal area network (PAN), Worldwide Interoperability for Microwave Access (WiMAX), public switched telephone network (PTSN), general packet radio service (GPRS), cellular networks including cellular data networks, and/or other types of communication networks.

In various embodiments, the computing system 10* may be designed to allow a plurality users 62* (via client devices 60*) to submit one or more open bids for one or more content access latencies. For example, in some embodiments, the computing system 10* may be designed to offer one or more levels of access (associated with one or more content access latencies) to a specific content 20 (e.g., a consumable media such as a feature length movie or news content such as financial or market news) by at least initially communicating (e.g., transmitting) at least one bidding tag 30 to one or more client devices 60*. The bidding tag 30 that may be transmitted to the one or more client devices 60* may be designed to solicit/elicit one or more open bids 40* from one or more users 62* via the one or more client devices 60*. In particular, the bidding tag 30 that may be transmitted to the one or more client devices 60* may be designed to facilitate the one or more client devices 60* receiving the bidding tag 30 to provide at least one interface, such as a graphical user interface (GUI), for soliciting one or more open bids 40* from one or more users 62*.

In various embodiments, the bidding tag 30 that may be transmitted may include data 32 that may identify the specific content 20 being offered for consumption, one or more content access latencies available for bidding, range of offer amounts that may be submitted by a user 62*, and/or other information that may be useful for soliciting open bids 40* from users 62*. For example, in some cases, the bidding tag 30 that may be transmitted or relayed by the computing system 10* may provide generic information related to a specific content 20 that is to be offered for consumption. For instance, a bidding tag 30 may contain just enough information about a specific content 20 being offered for consumption to make the specific content 20 being offered identifiable (e.g., identifiable as a particular type of news or a particular movie) without providing or disclosing the core component or components of the specific content 20 (e.g., core component of the content 20 that if revealed would render the content 20 essentially worthless). For example, if the specific content 20 to be offered for consumption is a movie, then the bidding tag 30 that is designed to elicit bids for such content 20 may include at least the title of the movie, and in some cases, additional data such as names of the cast and/or crew, movie trailer or trailers, and so forth.

If the specific content 20 to be offered for consumption is, on the other hand, financial or market news, then the bidding tag 30 that is communicated to one or more client devices 60* to elicit one or more open bids 40* for such a content 20 may merely identify the type of financial/market news (e.g., “Share price of ACME Corp. stocks on May 26, 2016) that is included in the specific content 20 without providing essential information (e.g., without providing the actual share price) related to the financial/market news. In yet another example, if the specific content 20 being offered for consumption is news related to a particular celebrity, then the bidding tag 30 that is communicated to the one or more client devices 60* to elicit one or more open bids 40* for such a specific content 20 may indicate that the specific content 20 is “celebrity news” or may indicate the name of the celebrity without indicating what the news related to the celebrity is all about (e.g., the bidding tag 30 may indicate that the specific content 20 is news about “Lindsey Lohan” without identifying the specific news related to Lindsey Lohan). Thus, in various implementations, a bidding tag 30 may provide certain generic information related to a specific content 20 being offered for consumption without providing core or essential data related to the specific content 20.

In various embodiments, in response at least in part to receiving a bidding tag 30 from the computing system 10*, a client device 60* may visually present (e.g., display) a GUI 200* (see FIGS. 2A, 2B, 2C, 2D, 2E, 2F, 2G, 2H, 2I, 2K, and 2M, which illustrate some exemplary GUIs 200*) for soliciting and/or submitting one or more open bids 40* for one or more content access latencies. In the example illustration of FIG. 1, each of the users 62* (e.g., user 62a, user 62b, user 62c, and user 62d) are illustrated as submitting a plurality of open bids 40* (e.g., open bid 40a from user 62a, open bid 40b from user 62b, open bid 40c from user 62c, and open bid 62d from user 62d) for one or more content access latencies. In some embodiments, the open bids 40* submitted by the users 62* may be submitted through, for example, the exemplary GUIs 200* illustrated in FIGS. 2A, 2B, 2C, 2D, 2E, 2F, 2G, 2H, 2I, 2K, and 2M.

In order to facilitate understanding of some of the concepts to be introduced herein, it will be assumed that open bids 40a and 40b submitted by user 62a and user 62b in FIG. 1 will be the highest open bids 40* indicating the highest offer fee amount or amounts (e.g., both open bids 40a and 40b may be offers for the same offer fee amount or the two open bids 40a and 40b may indicate the highest and the second highest bids indicating the highest offer fee amount and the second highest fee amount) among the plurality of open bids 40* (e.g., open bid 40a, open bid 40b, open bid 40c, and open bid 40d) submitted by the four users 62* (e.g., user 62a, user 62b, user 62c, and user 62d) in FIG. 1. It will also be further assumed that the open bid 40c submitted by user 62c is the third highest bid (e.g., the open bid 40c indicating the third highest fee offer amount) among the plurality of open bids 40* submitted by the users 62* and that the open bid 40d submitted by user 62d is the fourth highest bid (e.g., the open bid 40d indicating the fourth highest fee offer amount) among the plurality of open bids 40* submitted by the users 62*. As previously indicated, the open bids 40* submitted by the users 62* are for one or more content access latencies for accessing a specific content 20.

Note that the word “latency,” as will be used herein, may be in reference to a specific time delay for accessing a specific content 20. For example, in some embodiments, the word “latency,” as will be used herein, may be in reference to an increment or interval of time between some arbitrary point in time, such as the earliest point in time that a specific content 20 is available for consumption, and the point in time that the specific content 20 is actually made available or accessible. For example, in the case where the specific content 20 that is being offered for consumption includes a feature length movie, the related latency for accessing such a content 20 may be the amount of time between when the movie is initially released in theaters and the point in time that the movie is actually made available through, for example, the exemplary environment 100 of FIG. 1.

In the case where the specific content 20 relates to a price of a particular stock, the related latency may be the amount of time between when the price is first available through, for example, Dow Jones or Nasdaq and when the price is actually made accessible or released through, for example, the exemplary environment 100 of FIG. 1. In various implementations, the point in time in which the “latency clock” begins may not be very relevant since the point in time that the latency clock begins can be completely arbitrary (e.g., could begin when a movie is initially released in theaters or at some arbitrary point in time afterwards). That is, the phrase “latency,” as used herein, simply relates to a time increment or interval. Thus, in some embodiments, a more relevant aspect may be the amount of a particular latency (e.g., content access latency) with respect to other latencies (e.g., other content access latencies). For example, the amount of content access latency experienced by user 62a and user 62d (e.g., the two highest bidders) with respect to the amount of content access latency experienced by user 62b (e.g., third highest bidder) in accessing the specific content 20 may be a more important aspect.

Upon receiving a plurality of open bids 40* from a plurality of users 62* via one or more client devices 60* (note that in some extreme cases, a single client device 60* may be employed in order to submit multiple open bids 40* from multiple users 62*), the computing system 10* may be designed to determine which one or more of the plurality of open bids 40* submitted by the users 62* indicate at least the highest offer amount amongst the plurality of open bids 40*. In some cases, this may involve the computing system 10* ranking the open bids 40* from the highest bid to the lowest bid. In some cases, the open bids 40* that may be received by the computing system 10* may be grouped into the specific latencies that they are directed to. That is, in some embodiments, the open bids 40* that may be submitted by users 62* may be bids for one or more specific content access latencies. For these cases, a determination may be made for the highest bids (e.g., highest open bids indicating highest fee offer amounts) for each latency being bid on. For example, if two content access latencies are being offered for bidding—a first content access latency and a second content access latency—then determining the highest one or more open bids 40* for the first content access latency and then separately determining the highest one or more open bids 40* for the second content access latency in order to determine, for example, which user 62* gets access to the specific content 20 with the first content access latency and which user 62* gets access to the specific content 20 with the second content access latency.

In various embodiments, in response to making the determination as to which of the one or more of the plurality of open bids 40* indicate at least the highest offer amount amongst the plurality of open bids 40*, the computing system 10* may selectively release at least access to one or more of the plurality of users 62* (via one or more client device 60*) the specific content 20 with one or more content access latencies. In some embodiments, this may mean that access to the specific content 20 may be provided to various users 62* (e.g., client devices 60* associated with the various users 62*) at different points in time.

In some implementations, the computing system 10*, in addition to being able to release a specific content 20 to one or more users 62*, may also be designed to release (e.g., provide) to the one or more users 62* access to previous consumer information 22 and/or contextual information 24. The previous consumer information 22 that may be made accessible by the computing system 10* may provide various information related to users 62* who may have previously accessed a specific content 20. For example, if users 62a and 62d in FIG. 1 are given early access to a specific content 20 (e.g., a content 20 that is related to the price of a particular stock on a particular date) before the other users 62b and 62c, then the computing system 10* may provide to the client device 60b (associated with user 62b, who is getting a later access to the specific content 20) previous consumer information 22 that indicates, for example, how many other users (e.g., users 62a and 62d of FIG. 1) have already previously accessed the specific content 20, the identities of those other users 62a and 62d who have already accessed the specific content 20, and/or how those other users 62a and 62d may have previously viewed the specific content 20 (e.g., the communication channels such as bandwidth of the communication channels that were used by the other content consumers in order to access the content 20). In some cases, such information may prove valuable to user 62b (e.g., an institutional user such as a brokerage firm) receiving the specific content 20 when, for example, the user 62b is making business/financial decisions.

In some implementations, the previous consumer information 22 that may be released by the computing system 10* may be released at the same time or proximate to the point in time in which a bidding tag 30 is released to the client devices 60* by the computing system 10*. By providing such information to a user 62*, the user 62* may make a more informed decision as to whether to bid for the specific content 20. In other implementations, the previous consumer information 22 may be released by the computing system 10* to one or more client devices 60* at the same time or proximate to the point in time in which the specific content 20 is released to the one or more client devices 60*.

As indicated above, in some implementations, the computing system 10* may be additionally or alternatively designed to release to one or more users 62* (e.g., one or more client devices 60* associated with the one or more users 62*) contextual information 24 related to a specific content 20 that is being released to the one or more users 62*. In various embodiments, contextual information 24 that may be released may be data that provides information related to a specific content 20 and that may supplement the specific content 20 that is being released. For example, if the specific content 20 that is to be released by the computing system 10* is financial/market news (e.g., price of a particular stock or commodity on a particular date) then the computing system 10* may be further designed to release a corresponding contextual information 24 that provides historical financial/market data (e.g., historical prices of the particular stock or commodity). On the other hand, if the specific content 20 that is to be released by the computing system 10* is a consumable media such as a feature length movie, then the contextual information 24 that may be released by the computing system 10* may be one or more movie trailers that may be trailers for the movie or for another movie (e.g., another movie in the same genre). In some cases, such contextual information 24 may only be provided to those users 62* who have paid a higher premium for accessing the specific content 20. In other cases, however, a user 62* may actually pay a higher premium in order to avoid being provided with such contextual information 24. For example, if the content 20 being offered for consumption is a movie, than some content consumers (e.g., users 62*) may not wish to see movie trailers of other movies since such trailers are essentially advertisements. A more detailed discussion related to various aspects of the exemplary environment of FIG. 1 will be provided with respect to the processes and operations to be described herein.

Referring now to FIGS. 2A, 2B, 2C, 2D, 2E, 2F, 2G, 2H, 2I, 2K, and 2M, which illustrate exemplary GUIs 200a, 200b, 200c, 200d, 200e, 200f, 200g, 200h, 200i, 200k, and 200m that may be displayed by, for example, one or more of the client devices 60* of FIG. 1 in order to solicit/elicit one or more one open bids 40* from one or more users 62*. In various embodiments, the exemplary GUIs illustrated in FIGS. 2A, 2B, 2C, 2D, 2E, 2F, 2G, 2H, 2I, 2K, and 2M may be used by a user 62* in order to submit an open bid 40* for one or more content access latencies. In some embodiments, a bidding tag 30 that may be received by one or more client devices 62* may facilitate the one or more client devices 60* to display the exemplary GUIs 200a, 200b, 200c 200d, 200e, 200f, 200g, 200h, 200i, 200k, and 200m of FIGS. 2A, 2B, 2C, 2D, 2E, 2F, 2G, 2H, 2I, 2K, and 2M. For example, in some cases, the bidding tag 30 that may be received by one or more client devices 62* may include certain data 32 that may be used to generate the exemplary GUIs 200a, 200b, 200c 200d, 200e, 200f, 200g, 200h, 200i, 200k, and 200m.

Turning particularly now to FIG. 2A, which illustrates an exemplary GUI 200a for soliciting/submitting (e.g., soliciting from the perspective of a content provider and submitting from perspective of a user 62*) one or more open bids 40* for a specific content access latency for accessing a particular content. In particular, the exemplary GUI 200a includes a feature 202a (which is a box) for entering (e.g., inputting) a user elected fee amount (e.g., for electing a user elected fee amount from a plurality of undefined fee amounts) and feature 212a for entering the name of the specific content 20 to be bid on. Note that text 213a has already been entered into the feature 212a indicating the name of the specific content 20 to be bid on. The exemplary GUI 200a (herein simply “GUI 200a”) further includes feature 208a for accessing (e.g., acquiring and/or presenting) contextual information 24 (e.g., historical information related to share prices of ACME), feature 210a for accessing previous consumer information 22, and feature 206a for submitting (e.g., transmitting) an open bid 40* (e.g., an open bid 40* that indicates at least a user elected fee amount) by a user 62*. Note that features 206a, 208a, and/or 210a may be elected by a user 62* by “clicking” such features. Note further that the content access latency (as indicated by text 203a) that may be bid on through GUI 200a is not modifiable by a user 62* (e.g., a preset content access latency).

Referring now to FIG. 2B, which shows another GUI 200b that may be presented by one or more client devices 60* of FIG. 1 for soliciting/submitting one or more open bids 40* for a specific content access latency that may be entered by a user 62*. As illustrated, the GUI 200b includes a feature 202b (which is a box) for entering (e.g., inputting) a user elected fee amount (e.g., for electing a user elected fee amount from a plurality of undefined fee amounts) similar to the feature 202a of FIG. 2A. However, unlike the GUI 200a of FIG. 2A, in this case, the GUI 200b includes a feature 204b (another box) that allows a user 62* to enter a user elected content access latency (e.g., for entering a user elected content access latency from a plurality of undefined content access latencies). GUI 200b, as further illustrated, includes text 212b that identifies the content 20 that is being bid on, text 209b that indicates contextual information 24 (e.g., historical market information) related to the content 20, and text 211b that indicates previous consumer information 22 (e.g., number and identity of other users 62* who have previous viewed the content 20 that is being bid on through the GUI 200b). In some implementations, the information used to populate GUI 200b such as text 212b, text 209b, and text 211b may have been provided through a bidding tag 30 received by the one or more client devices 60*.

Turning now to FIG. 2C, which shows yet another GUI 200c that may be presented by the one or more client devices 60* of FIG. 1 in order to solicit/submit one or more open bids 40*. As illustrated, GUI 200c includes text 212c that identifies the specific content 20 that is available for consumption, text 203c that indicates a non-modifiable content access latency that is to be bid on, and feature 202c for selecting a user elected fee amount from a plurality of predefined/indicated fee amounts. In particular, feature 202c includes a vertical scroll bar 205c that allows a user 62* to scroll through a plurality of predefined and indicated fee amounts in order to select a specific fee amount as the user elected fee or offer amount.

FIG. 2D shows a GUI 200d that allows a user 62* to select a user elected fee amount from a plurality of predefined/indicated fee amounts similar to the GUI 200c of FIG. 2C as well as to select a user elected amount of content access latency from a plurality of predefined/indicated amounts of content access latencies. In particular, GUI 200d includes feature 202d for selecting the user elected fee amount from the plurality of predefined/indicated fee amounts and feature 204d for selecting a user elected amount of content access latency from the plurality of predefined/indicated amounts of content access latencies. Text 212d identifies the specific content 20 that is being offered for consumption and that is to be bid on.

FIG. 2E illustrates a GUI 200e for entering multiple user elected fee amounts and for entering multiple user elected content access latencies for multiple preferences. In particular, GUI 200e include a feature 221e for entering a first user elected fee amount and a feature 231e for entering a first user elected content access latency for a first preference, a feature 222e for entering a second user elected fee amount and a feature 232e for entering a second user elected content access latency for a second preference, and a feature 223e for entering a third user elected fee amount and a feature 233e for entering a third user elected content access latency for a third preference. Note that the first preference being a preferred option over the second preference, and the second preference being a preferred option over the third preference. Text 212e identifies the specific content 20 that is being offered for consumption and that is to be bid on.

FIG. 2F illustrates a GUI 200f for entering multiple user elected fee amounts for multiple predefined (non-modifiable) content access latencies for multiple preferences. In particular, GUI 200f includes a feature 221f for entering a first user elected fee amount for a first preference and text 241f that indicates a predefined first content access latency associated with the first preference, a feature 222f for entering a second user elected fee amount for a second preference and text 242f that indicates a predefined second content access latency associated with the second preference, and a feature 223f for entering a third user elected fee amount for a third preference and text 243f that indicates a predefined content access latency associated with the third preference. Text 212f identifies the specific content 20 that is being offered for consumption and that is to be bid on.

FIGS. 2G, 2H, 2I, 2K, and 2M illustrate various GUIs for that may be presented by the one or more client devices 60* of FIG. 1 in order to solicit/submit one or more open bids 40* for various types of content. For example, FIG. 2G illustrates a GUI 200g for soliciting/submitting one or more open bids 40* for a user elected content latency for accessing a particular type of consumable media (e.g., digital novel/book with the title “The Godmother” as indicated by text 212g). Note that GUI 200g includes feature 213g for acquiring/presenting contextual data 24 in the form of an excerpt from the content (e.g., digital novel) being offered for consumption. In contrast, FIG. 2H illustrates a GUI 200h for soliciting/submitting one or more open bids 40* for a user elected content access latency for accessing a particular type of news content (e.g., human interest news in the form of celebrity news as indicated by text 212h). FIG. 2I illustrates a GUI 200i for soliciting/submitting one or more open bids 40* for accessing governmental/regulatory news (e.g., interest rate news as indicated by text 212i). Note that in GUI 200i, no content access latency is indicated and there is no feature for entering a user elected or requested content access latency. This is because in some implementations, users 62* may submit open bids 40* for an unspecified or already known content access latency. In such implementations, the highest bidders (e.g., users 62* who submit bids with the highest offer amounts) may simply be provided with access to the specific content 20 with the lowest content access latency or latencies.

FIG. 2K illustrates a GUI 200k for soliciting/submitting one or more open bids 40* for accessing agricultural news (e.g., a summer crop report as indicated by text 212k). Note that in GUI 200k, a user 62* is allowed to select a particular content to bid on through feature 212k from a plurality of different content indicated through the feature 212k. Finally, FIG. 2M illustrates a GUI 200m for soliciting/submitting one or more open bids 40* for a user elected content access latency for accessing a particular type of consumable media (e.g. a feature length movie titled “Star Battle” as indicated by text 212m). A more detailed discussion related to the exemplary GUIs 200a, 200b, 200c 200d, 200e, 200f, 200g, 200h, 200i, 200k, and 200m illustrated in FIGS. 2A, 2B, 2C, 2D, 2E, 2F, 2G, 2H, 2I, 2K, and 2M will be provided below with respect to the various processes and operations to be described herein.

Referring now to FIGS. 3A and 3B, illustrating two block diagrams representing two different implementations of the computing system 10* of FIG. 1 and that are designed to execute the operations and processes to be described herein. In particular, and as will be further described herein, FIG. 3A illustrates a computing system 10′ that is the “hardwired” or “hard” implementation of a system that can implement the operations and processes to be described herein. The computing system 10′ may comprise certain logic modules including, for example, an open bid obtaining module 102′, a highest offer amount open bid ascertaining module 104′, and/or a content access releasing module 106′ that are implemented using purely hardware or circuitry components (e.g., application specific integrated circuit or “ASIC”). In contrast, FIG. 3B illustrates a computing system 10″ that is the “soft” implementation of a system that can implement the operations and processes to be described herein. In various embodiments, the computing system 10″ may also include certain logic modules including, for example, an open bid obtaining module 102″, a highest offer amount open bid ascertaining module 104″, and/or a content access releasing module 106″ that are implemented using electronic circuitry (e.g., one or more processors 116 including one or more microprocessors, controllers, etc.) executing one or more programming instructions (e.g., software in the form of computer readable instructions 152—see FIG. 3B).

The embodiments of the computing system 10* illustrated in FIGS. 3A and 3B are two extreme implementations of a system in which all of the logic modules (e.g., the open bid obtaining module 102′, the highest offer amount open bid ascertaining module 104′, and the content access releasing module 106′) are implemented using purely hardware solutions (e.g., circuitry such as ASIC) as illustrated in FIG. 3A or in which all of the logic modules (e.g., the open bid obtaining module 102″, the highest offer amount open bid ascertaining module 104″, and the content access releasing module 106″) are implemented using software solutions (e.g., programmable instructions in the form of computer readable instructions 152 being executed by hardware such as one or more processors 116) as illustrated in FIG. 3B. Since there are many ways of combining hardware, software, and/or firmware in order to implement the various logic modules (e.g., the open bid obtaining module 102*, the highest offer amount open bid ascertaining module 104*, and the content access releasing module 106*), only the two extreme implementations (e.g., the purely hardware solution as illustrated in FIG. 3A and the software solution of FIG. 3B) are illustrated here. It should be noted here that with respect to the “soft” implementation illustrated in FIG. 3B, hardware in the form of circuitry such as one or more processors 116 are still needed in order to execute the software. Further details related to the two implementations of the computing system 10* illustrated in FIGS. 3A and 3B will be provided in greater detail below.

In some instances, one or more components may be referred to herein as “configured to,” “configured by,” “configurable to,” “operable/operative to,” “adapted/adaptable,” “able to,” “conformable/conformed to,” “designed to,” etc. Those skilled in the art will recognize that such terms (e.g., “configured to”) generally encompass active-state components and/or inactive-state components and/or standby-state components, unless context requires otherwise.

Referring particularly now to FIG. 3A, which illustrates a block diagram of a computing system 10′ that includes an open bid obtaining module 102′, a highest offer amount open bid ascertaining module 104′, a content access releasing module 106′, a memory 114, one or more processors 116 (e.g., one or more microprocessors), and/or a network interface 112 (e.g., one or more network interface cards or “NICs”). In various embodiments, the memory 114 may store various content 21 including, for example, the specific content 20 (e.g., news content or consumable media such as a feature length movie, a recording of a sports event, or a recording of a concert) depicted in FIG. 1.

In various embodiments, the open bid obtaining module 102′ of FIG. 3A is a logic module that may be designed to, among other things, obtain (e.g., acquire) a plurality of open bids 40* for one or more content access latencies, each of the plurality of open bids 40* to be obtained indicating one or more offer amounts submitted by a plurality of users 62* that the plurality of users 62* are offering in exchange for being provided at least access to a specific content 20 with the one or more content access latencies. In contrast, the highest offer amount open bid ascertaining module 104′ of FIG. 3A is a logic module that may be configured to ascertain or determine which one or more of the plurality of open bids 40* indicate at least the highest offer amount amongst the plurality of open bids 40*. The content access releasing module 106′ of FIG. 3A, on the other hand, is a logic module that may be configured to release or provide at least access to the specific content 20 to one or more of the plurality of users 62* in accordance, at least in part, with the ascertaining of which of the one or more of the plurality of open bids indicate at least the highest offer amount amongst the plurality of open bids 40*.

Turning now to FIG. 3B, which illustrates a block diagram of another computing system 10″ that can implement the operations and processes to be described herein. As indicated earlier, the computing system 10″ in FIG. 3B is merely the “soft” version of the computing system 10′ of FIG. 3A because the various logic modules: the open bid obtaining module 102″, the highest offer amount open bid ascertaining module 104″, and the content access releasing module 106″ are implemented using one or more processors 116 (e.g., one or more microprocessors or controllers) executing software (e.g., computer readable instructions 152) rather than being implemented using purely hardware (e.g., ASIC) solutions as was the case in the computing system 10′ of FIG. 3A. Thus, the open bid obtaining module 102″, the highest offer amount open bid ascertaining module 104″, and the content access releasing module 106″ of FIG. 3B may be designed to execute the same functions as the open bid obtaining module 102′, the highest offer amount open bid ascertaining module 104′, and the content access releasing module 106′ of FIG. 3A. The computing system 10″, as illustrated in FIG. 3B, may include other components (e.g., the network interface 112, and so forth) that are the same or similar to the other components that may be included in the computing system 10′ of FIG. 3A. Note that in the embodiment of the computing system 10″ illustrated in FIG. 3B, the various logic modules (e.g., the open bid obtaining module 102″, the highest offer amount open bid ascertaining module 104″, and the content access releasing module 106″) may be implemented by the one or more processors 116 (or other types of circuitry such as field programmable gate arrays or FPGAs) executing one or more computer readable instructions 152 stored in memory 114.

In various embodiments, the memory 114 of the computing system 10′ of FIG. 3A and the computing system 10″ of FIG. 3B may comprise of one or more of mass storage device, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices.

Turning now to FIG. 4A illustrating a particular implementation of the open bid obtaining module 102* (e.g., the open bid obtaining module 102′ or the open bid obtaining module 102″) of FIGS. 3A and 3B. As illustrated, the open bid obtaining module 102* may include one or more sub-logic modules in various alternative implementations. For example, in various embodiments, the open bid obtaining module 102* may include an open bid eliciting module 402, which may further include a bidding tag relaying module 404. Specific details related to the open bid obtaining module 102* as well as the above-described sub-modules of the open bid obtaining module 102* will be provided below with respect to the operations and processes to be described herein.

Referring now to FIG. 4B illustrating a particular implementation of the highest offer amount open bid ascertaining module 104* (e.g., the highest offer amount open bid ascertaining module 104′ or the highest offer amount open bid ascertaining module 104″) of FIGS. 3A and 3B. As illustrated, the highest offer amount open bid ascertaining module 104* may include one or more sub-logic modules in various alternative implementations. For example, in various embodiments, the highest offer amount open bid ascertaining module 104* may include an open bid comparing module 406, a user ascertaining module 408, a lowest offer amount open bid ascertaining module 410, and/or an open bid ranking module 412. Specific details related to the highest offer amount open bid ascertaining module 104* as well as the above-described sub-modules of the highest offer amount open bid ascertaining module 104* will be provided below with respect to the operations and processes to be described herein.

FIG. 4C illustrates a particular implementation of the content access releasing module 106* (e.g., the content access releasing module 106′ or the content access releasing module 106″) of FIG. 3A or 3B. As illustrated, the content access releasing module 106* may include one or more sub-logic modules in various alternative embodiments. For example, in various embodiments, the content access releasing module 106* may include a content relaying module 414, a link relaying module 416, a previous user information access releasing module 418, a contextual information access releasing module 420 and/or an instructions releasing module 422. Specific details related to the content access releasing module 106*, as well as the above-described sub-modules of the content access releasing module 106*, will be provided below with respect to the operations and processes to be described herein.

A more detailed discussion related to the computing system 10* (e.g., the computing system 10′ of FIG. 3A or the computing system 10″ of FIG. 3B) discussed above will now be provided with respect to the processes and operations to be described herein. FIG. 5 illustrates an operational flow 500 representing example operations for, among other things, releasing of a particular content in accordance with one or more of a plurality of open bids 40 for one or more content access latencies that were obtained from one or more users 62* via, for example, one or more client devices 60*. In various implementations, these operations may be implemented by the computing system 10* of FIG. 3A or 3B (as well as FIG. 1).

In FIG. 5 and in the following figures that include various examples of operational flows, discussions and explanations will be provided with respect to the computing system 10* described above and as illustrated in FIGS. 3A, 3B, 4A, 4B, and 4C and/or with respect to other examples (e.g., as provided in FIGS. 1, 2A, 2B, 2C, 2D, 2E, 2F, 2G, 2H, 2I, 2K, and 2M) and contexts. However, it should be understood that the operational flows may be executed in a number of other environments and contexts, and/or in modified versions of FIGS. 1, 2A, 2B, 2C, 2D, 2E, 2F, 2G, 2H, 2I, 2K, 2M, 3A, 3B, 4A, 4B, and/or 4C. Also, although the various operational flows are presented in the sequence(s) illustrated, it should be understood that the various operations may be performed in orders other than those which are illustrated, or may be performed concurrently.

Further, in FIG. 5 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 5 as well as the other operations to be described herein are performed by at least one of a machine, an article of manufacture, or a composition of matter unless indicated otherwise.

For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

In any event, after a start operation, the operational flow 500 of FIG. 5 may move to an open bid acquiring operation 502 for acquiring from a plurality of users a plurality of open bids for one or more content access latencies, each of the plurality of open bids to be received indicating one or more offer amounts submitted by the plurality of users that the plurality of users are offering in exchange for being provided at least access to a specific content with the one or more content access latencies. For instance, and as illustration, the open bid obtaining module 102* of the computing system 10* of FIG. 3A or 3B (e.g., the open bid obtaining module 102′ of FIG. 3A or the open bid obtaining module 102″ of FIG. 3B) acquiring or obtaining from a plurality of users 62* (e.g., two or more users 62*) a plurality of open bids 40* for one or more content access latencies (e.g., time delays for accessing a specific content 20 following some arbitrary point in time such as the earliest point in time in which the specific content 20 can be made accessible or available), each of the plurality of open bids 40* to be received indicating one or more offer amounts submitted by the plurality of users 62* that the plurality of users 62* are offering in exchange for being provided at least access to a specific content 20 with the one or more content access latencies. In various embodiments, an open bid 40* may be a user submitted offer that indicates a user elected fee amount that a user 62* is offering in exchange for being allowed to access the specific content 20 with a specific amount of content access latency.

Operational flow 500 may also include a highest offer amount open bid determining operation 504 for determining which one or more of the plurality of open bids indicate at least the highest offer amount amongst the plurality of open bids. For instance, the highest offer amount open bid ascertaining module 104* (e.g., the highest offer amount open bid ascertaining module 104′ of FIG. 3A or the highest offer amount open bid ascertaining module 104″ of FIG. 3B) of the computing system 10* of FIG. 3A or 3B determining or ascertaining which one or more of the plurality of open bids 40* indicate at least the highest offer amount amongst the plurality of open bids 40* that were acquired by, for example, the computing system 10*.

As further illustrated in FIG. 5, operational flow 500 may also include a content access providing operation 506 for providing at least access to the specific content to one or more of the plurality of users in accordance, at least in part, with the determining. For instance, the content access releasing module 106* (e.g., content access releasing module 106′ of FIG. 3A or the content access releasing module 106″ of FIG. 3B) of the computing system 10* of FIG. 3A or 3B providing or releasing at least access to the specific content 20 to one or more of the plurality of users 62* (e.g., releasing the specific content 20 to one or more client devices 60* associated with the one or more of the plurality of users 62*) in accordance, at least in part, with the determining which of the one or more of the plurality of open bids 40* indicated at least the highest offer amount amongst the plurality of open bids 40*.

As will be described below, the open bid acquiring operation 502, the highest offer amount open bid determining operation 504, and the content access providing operation 506 may be executed in a variety of different ways in various alternative implementations. FIGS. 6A, 6B, 6C, 6D, 6E, 6F, 6G, 6H, 6I, 6J, 6K, 6L, 6M, 6N, 6P, and 6Q for example, illustrate at least some of the alternative ways that the open bid acquiring operation 502 of FIG. 5 may be executed in various alternative implementations. In some cases, for example, the open bid acquiring operation 502 may actually include or involve an operation 602 for acquiring the plurality of open bids by acquiring the plurality of open bids via one or more wireless and/or wired networks as illustrated in FIG. 6A. For instance, the open bid obtaining module 102* of the computing system 10* (e.g., the computing system 10′ of FIG. 3A or the computing system 10″ of FIG. 3B) acquiring the plurality of open bids 40* by acquiring the plurality of open bids 40* via one or more wireless and/or wired networks 5 (e.g., cellular data network, WLAN, WiMAX, PTSN, and so forth) using, for example, a network interface 112 (e.g., one or more network interface cards).

As further illustrated in FIG. 6A, in the same or alternative implementations, the open bid acquiring operation 502 may additionally or alternatively include an operation 603 for acquiring from the plurality of users the plurality of open bids by acquiring the plurality of open bids from a plurality of client devices associated with the plurality of users. For instance, the open bid obtaining module 102* of the computing system 10* of FIG. 3A or 3B acquiring (e.g., obtaining) from the plurality of users 62* the plurality of open bids 40* by acquiring the plurality of open bids 40* from a plurality of client devices 60* associated with the plurality of users 62*. Note that in some cases multiple users 62* may use a single client device 60* in order to submit multiple open bids 40*.

For example, in some implementations, the open bid acquiring operation 502 may actually include or involve an operation 604 for acquiring from the plurality of users the plurality of open bids by soliciting the plurality of open bids from the plurality of users. For instance, the open bid obtaining module 102* including the open bid eliciting module 402 (see FIG. 4A) of the computing system 10* of FIG. 3A or 3B acquiring from the plurality of users 62* the plurality of open bids 40* when the open bid eliciting module 402 solicits (elicits) the plurality of open bids 40* from the plurality of users 62*.

As further illustrated in FIGS. 6A, 6B, 6C, 6D, 6E, 6F, 6G, 6H, 6I, 6J, 6K, 6L, 6M, and 6N, operation 604 may include or involve one or more additional operations in various alternative implementations including, in some cases, an operation 605 for soliciting the plurality of open bids from the plurality of users by transmitting to one or more client devices associated with the plurality of users at least one bidding tag designed to facilitate the one or more client devices to provide at least one interface for soliciting the plurality of open bids from the plurality of users as illustrated in FIG. 6A. For instance, the open bid eliciting module 402 including the bidding tag relaying module 404 (see FIG. 4A) of the computing system 10* of FIG. 3A or 3B soliciting the plurality of open bids 40* from the plurality of users 62* when the bidding tag relaying module 404 transmits (e.g., relays) to one or more client devices 60* associated with the plurality of users 62* at least one bidding tag 30 that includes data 32 to facilitate the one or more client devices 60* to provide at least one interface (e.g., an audio or visual channel) for soliciting the plurality of open bids 40* from the plurality of users 62*. In various embodiments, a client device 60* may be associated with one or more users 62* when the one or more users 62* are using, have access rights, and/or have other log-in privileges with the client device 60*.

In some implementations, operation 605 may further include or involve an operation 606 for transmitting to the one or more client devices associated with the plurality of users the at least one bidding tag that is designed to facilitate the one or more client devices to provide the at least one interface for soliciting the plurality of open bids by transmitting to the one or more client devices at least one bidding tag that is designed to facilitate the one or more client devices to provide the at least one interface, the bidding tag to be transmitted identifying the specific content. For instance, the bidding tag relaying module 404 of the computing system 10* of FIG. 3A or 3B transmitting to the one or more client devices 60* associated with the plurality of users 62* the at least one bidding tag 30 that is designed to facilitate the one or more client devices 60* to provide the at least one interface for soliciting the plurality of open bids 40* by transmitting (e.g., relaying) to the one or more client devices 60* at least one bidding tag 30 that includes data 32 that facilitates the one or more client devices 60* to provide the at least one interface, the bidding tag 30 to be transmitted identifying the specific content 20.

In some implementations, operation 606 may further include or involve an operation 607 for transmitting to the one or more client devices the at least one bidding tag that is designed to facilitate the one or more client devices to provide the at least one interface for soliciting the plurality of open bids by transmitting to the one or more client devices at least one bidding tag that is designed to facilitate the one or more client devices to provide at least the one interface, the bidding tag to be transmitted identifying the specific content as being a particular news content. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one (audio and/or visual) interface for soliciting the plurality of open bids 40* by transmitting (e.g., relaying) to the one or more client devices 60* at least one bidding tag 30 that includes data 32 that facilitates the one or more client devices 60* to provide at least the one interface, the bidding tag 30 to be transmitted identifying the specific content 20 as being a particular news content (e.g., financial or market news such as stock or commodity prices, regulatory news, news from the Federal Reserve, and so forth).

In some implementations, operation 606 may involve or include an operation 608 for transmitting to the one or more client devices the at least one bidding tag that is designed to facilitate the one or more client devices to provide the at least one interface for soliciting the plurality of open bids by transmitting to the one or more client devices at least one bidding tag that is designed to facilitate the one or more client devices to provide at least the one interface, the bidding tag to be transmitted identifying the specific content as being a particular consumable media. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one interface for soliciting the plurality of open bids 40* by transmitting to the one or more client devices 60* at least one bidding tag 30 that includes data 32 that facilitates the one or more client devices 60* to provide at least the one interface, the bidding tag 30 to be transmitted identifying the specific content 20 as being a particular consumable media (e.g., a particular movie, a recording of a particular sporting event, a digital novel, and so forth).

In the same or alternative implementations, operation 605 may additionally or alternatively include an operation 609 for transmitting to the one or more client devices associated with the plurality of users the at least one bidding tag that is designed to facilitate the one or more client devices to provide at least one interface for soliciting the plurality of open bids by transmitting to the one or more client devices at least one bidding tag that is designed to facilitate the one or more client devices to provide at least the one interface, the bidding tag to be transmitted identifying at least one content access latency available for bidding as illustrated in FIG. 6B. For instance, the bidding tag relaying module 404 of the computing system 10* of FIG. 3A or 3B transmitting to the one or more client devices 60* associated with the plurality of users 62* the at least one bidding tag 30 that is designed to facilitate the one or more client devices 60* to provide at least one interface for soliciting the plurality of open bids 40* by transmitting (e.g., relaying) to the one or more client devices 60* at least one bidding tag 30 that includes data 32 that facilitates the one or more client devices 60* to provide at least the one interface, the bidding tag 30 to be transmitted or relayed identifying at least one content access latency available for bidding.

As further illustrated in FIG. 6B, in some implementations operation 609 may actually include or involve an operation 610 for transmitting to the one or more client devices the at least one bidding tag that identifies the at least one content access latency available for bidding by transmitting to the one or more client devices at least one bidding tag that identifies a plurality of different content access latencies available for bidding. For instance, the bidding tag relaying module 404 of the computing system 10* of FIG. 3A or 3B transmitting to the one or more client devices 60* the at least one bidding tag 30 that identifies the at least one content access latency available for bidding by transmitting to the one or more client devices 60* at least one bidding tag 30 that identifies a plurality of different content access latencies available for bidding.

In some implementations, operation 609 may actually include or involve an operation may actually involve or include an operation 611 for transmitting to the one or more client devices the at least one bidding tag that identifies the at least one content access latency available for bidding by transmitting to the one or more client devices at least one bidding tag that identifies a range of content access latencies available for bidding. For instance, the bidding tag relaying module 404 of the computing system 10* of FIG. 3A or 3B transmitting to the one or more client devices 60* the at least one bidding tag 30 that identifies the at least one content access latency available for bidding by transmitting to the one or more client devices 60* at least one bidding tag 30 that identifies a range of content access latencies (e.g., latencies of 1 microseconds to 15 microseconds for accessing price of a particular stock on a particular day when the price of the particular stock reaches a particular level) available for bidding.

As further illustrated in FIG. 6B, operation 605 in various implementations may additionally or alternatively include or involve an operation 612 for transmitting to the one or more client devices associated with the plurality of users the at least one bidding tag that is designed to facilitate the one or more client devices to provide the at least one interface for soliciting the plurality of open bids by transmitting to the one or more client devices at least one bidding tag that is designed to facilitate the one or more client devices to provide at least the one interface, the bidding tag to be transmitted identifying a plurality of different predefined fee amounts available for bid submission by a user for at least one particular content access latency. For instance, the bidding tag relaying module 404 of the computing system 10* of FIG. 3A or 3B transmitting to the one or more client devices 60* associated with the plurality of users 62* the at least one bidding tag 30 that is designed to facilitate the one or more client devices 60* to provide the at least one interface for soliciting the plurality of open bids 40* by transmitting (e.g., relaying) to the one or more client devices 60* at least one bidding tag 30 that includes data 32 that facilitates the one or more client devices 60* to provide at least the one interface, the bidding tag 30 to be transmitted or relayed identifying a plurality of different predefined fee amounts (e.g., $250, $300, $350, and so forth) available for bid submission by a user 62* for at least one particular content access latency. In other words, the bidding tag 30 that may be transmitted to the one or more client devices 60* may indicate the different offer amounts that a user 62* may offer through a bid 40* in order to be able to “get” a particular content access latency.

In some implementations, operation 605 may additionally or alternatively include an operation 613 for transmitting to the one or more client devices associated with the plurality of users the at least one bidding tag that is designed to facilitate the one or more client devices to provide the at least one interface for soliciting the plurality of open bids by transmitting to the one or more client devices at least one bidding tag that is designed to facilitate the one or more client devices to provide at least the one interface, the bidding tag to be transmitted identifying a range of predefined fee amounts available for bid submission by a user for at least one particular content access latency. For instance, the bidding tag relaying module 404 of the computing system 10* of FIG. 3A or 3B transmitting to the one or more client devices 60* associated with the plurality of users 62* the at least one bidding tag 30 that is designed to facilitate the one or more client devices 60* to provide the at least one interface for soliciting the plurality of open bids 40* by transmitting to the one or more client devices 60* at least one bidding tag 30 that includes data 32 that facilitates the one or more client devices 60* to provide at least the one interface, the bidding tag 30 to be transmitted or relayed identifying a range of predefined fee amounts (e.g., $150,000 to $650,000 or identifying a maximum or a minimum such as at least $150,000) available for bid submission by a user 62* for at least one particular content access latency.

In the same or alternative implementations, operation 605 may additionally or alternatively include an operation 614 for transmitting to the one or more client devices associated with the plurality of users the at least one bidding tag that is designed to facilitate the one or more client devices to provide the at least one interface for soliciting the plurality of open bids by transmitting to the one or more client devices at least one bidding tag that is designed to facilitate the one or more client devices to provide at least one interface that is a channel for soliciting submission of at least one open bid for accessing the specific content with a particular content access latency as illustrated in FIG. 6C. For instance, the bidding tag relaying module 404 of the computing system 10* of FIG. 3A or 3B transmitting to the one or more client devices 60* associated with the plurality of users 62* the at least one bidding tag 30 that is designed to facilitate the one or more client devices 60* to provide the at least one interface for soliciting (e.g., eliciting) the plurality of open bids 40* by transmitting to the one or more client devices 60* at least one bidding tag 30 that includes data 32 that facilitates the one or more client devices 60* to provide at least one interface that is a channel for soliciting or eliciting submission of at least one open bid 40* for accessing the specific content 20 with a particular content access latency.

In some implementations, operation 614 may further include or involve an operation 615 for transmitting to the one or more client devices at least one bidding tag that is designed to facilitate the one or more client devices to provide at least one interface that is a channel for requesting submission of at least one open bid for accessing the specific content with a particular content access latency by transmitting to the one or more client devices at least one bidding tag that is designed to facilitate the one or more client devices to provide at least one interface that is a channel for soliciting submission of, as well as receiving of, the at least one open bid for accessing the specific content with a particular content access latency. For instance, the bidding tag relaying module 404 of the computing system 10* of FIG. 3A or 3B transmitting to the one or more client devices 60* at least one bidding tag 30 that is designed to facilitate the one or more client devices 60* to provide at least one interface that is a channel for soliciting or eliciting submission of at least one open bid 40* for accessing the specific content 20 with a particular content access latency by transmitting to the one or more client devices 60* at least one bidding tag 30 that includes data 32 that facilitates the one or more client devices 60* to provide at least one interface that is a channel for requesting submission of, as well as receiving of, the at least one open bid 40* for accessing the specific content 20 with a particular content access latency.

In some cases, operation 605 may additionally or alternatively include or involve an operation 616 for transmitting to the one or more client devices associated with the plurality of users the at least one bidding tag that is designed to facilitate the one or more client devices to provide the at least one interface for soliciting the plurality of open bids by transmitting to the one or more client devices at least one bidding tag that is designed to facilitate the one or more client devices to provide at least one audio interface for soliciting the plurality of open bids. For instance, the bidding tag relaying module 404 of the computing system 10* of FIG. 3A or 3B transmitting to the one or more client devices 60* associated with the plurality of users 62* the at least one bidding tag 30 that is designed to facilitate the one or more client devices 60* to provide the at least one interface for soliciting (e.g., eliciting) the plurality of open bids 40* by transmitting (e.g., relaying) to the one or more client devices 60* at least one bidding tag 30 that includes data 32 that facilitates the one or more client devices 60* to provide at least one audio interface for soliciting (e.g. eliciting) the plurality of open bids 40*.

Referring now to FIG. 6D, in some implementations, operation 605 may additionally or alternatively include or involve an operation 617 for transmitting to the one or more client devices associated with the plurality of users the at least one bidding tag that is designed to facilitate the one or more client devices to provide the at least one interface for soliciting the plurality of open bids by transmitting to the one or more client devices at least one bidding tag that is designed to facilitate the one or more client devices to provide at least one visual interface for soliciting the plurality of open bids. For instance, the bidding tag relaying module 404 of the computing system 10* of FIG. 3A or 3B transmitting to the one or more client devices 60* associated with the plurality of users 62* the at least one bidding tag 30 that is designed to facilitate the one or more client devices 60* to provide the at least one interface for soliciting the plurality of open bids 40* by transmitting (e.g., relaying) to the one or more client devices 60* at least one bidding tag 30 that includes data 32 that facilitates the one or more client devices 60* to provide at least one visual interface for soliciting (e.g., eliciting) the plurality of open bids 40*.

As further illustrated in FIG. 6D, operation 617 may further include or involve one or more additional operations in various alternative implementations. For example, in some implementations, operation 617 may further include an operation 618 for transmitting to the one or more client devices the at least one bidding tag that is designed to facilitate the one or more client devices to provide the at least one visual interface for soliciting the plurality of open bids by transmitting to the one or more client devices at least one bidding tag that is designed to facilitate the one or more client devices to provide at least one graphical user interface (GUI) for soliciting at least one open bid. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one visual interface for soliciting the plurality of open bids 40* by transmitting (e.g., relaying) to the one or more client devices 60* at least one bidding tag 30 that includes data 32 that facilitates the one or more client devices 60* to provide at least one GUI (e.g., GUI 200* of FIG. 2A, 2B, 2C, 2D, 2E, 2F, 2G, 2H, 2I, 2K, or 2M) for soliciting or eliciting at least one open bid 40*.

In various implementations, operation 618 may further include or involve an operation 619 for transmitting to the one or more client devices the at least one bidding tag that is designed to facilitate the one or more client devices to provide the at least one GUI for soliciting the at least one open bid by transmitting to the one or more client devices at least one bidding tag that is designed to facilitate the one or more client devices to provide at least one GUI that includes at least one feature for electing at least one user elected fee amount. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI for soliciting the at least one open bid 40* by transmitting to the one or more client devices 60* at least one bidding tag 30 that includes data 32 that facilitates the one or more client devices 60* to provide at least one GUI (e.g., GUI 200a, 200b, 200c, or 200d of FIG. 2A, 2B, 2C, or 2D) that includes at least one feature (e.g., feature 202a, 202b, 202c, or 202d of FIG. 2A, 2B, 2C, or 2D) for electing at least one user elected fee amount.

As further illustrated in FIG. 6D, operation 619 may additionally include or involve one or more additional operations including, in some cases, an operation 620 for transmitting to the one or more client devices the at least one bidding tag that is designed to facilitate the one or more client devices to provide the at least one GUI that includes the at least one feature for electing the at least one user elected fee amount by transmitting to the plurality of client devices at least one bidding tag that is designed to facilitate the one or more client devices to provide at least one GUI that includes at least one feature for entering the user elected fee amount. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI that includes the at least one feature for electing the at least one user elected fee amount by transmitting to the plurality of client devices 60* at least one bidding tag 30 that includes data 32 that facilitates the one or more client devices 60* to provide at least one GUI (e.g., GUI 200a or GUI 200b of FIG. 2A or 2B) that includes at least one feature (e.g., feature 202a or 202b of FIG. 2A or 2B) for entering the user elected fee amount.

In some cases, operation 619 may additionally or alternatively involve or include an operation 621 for transmitting to the one or more client devices the at least one bidding tag that is designed to facilitate the one or more client devices to provide the at least one GUI that includes the at least one feature for electing the at least one user elected fee amount by transmitting to the one or more client devices at least one bidding tag that is designed to facilitate the one or more client devices to provide at least one GUI that includes at least one feature for selecting the user elected fee amount from a plurality of varying fee amounts that are selectable through the at least one feature. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI that includes the at least one feature for electing the at least one user elected fee amount by transmitting (e.g., relaying) to the one or more client devices 60* at least one bidding tag 30 that includes data 32 that facilitates the one or more client devices 60* to provide at least one GUI (e.g., GUI 200c or 200d) that includes at least one feature (e.g., feature 202c or 200d of FIG. 2C or 2D) for selecting the user elected fee amount from a plurality of varying fee amounts that are selectable through the at least one feature 202c or 202d.

As further illustrated in FIG. 6D, operation 621 in some cases may further include or involve an operation 622 for transmitting to the one or more client devices the at least one bidding tag that is designed to facilitate the one or more client devices to provide the at least one GUI that includes the at least one feature for selecting the user elected fee amount from the plurality of varying fee amounts that are selectable through the at least one feature by transmitting to the one or more client devices at least one bidding tag that is designed to facilitate the one or more client devices to provide at least one GUI that includes at least one feature for selecting the user elected fee amount from a plurality of varying fee amounts that are identified by the at least one GUI. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI that includes the at least one feature for selecting the user elected fee amount from the plurality of varying fee amounts that are selectable through the at least one feature by transmitting to the one or more client devices 60* at least one bidding tag 30 that includes data 32 that facilitates the one or more client devices 60* to provide at least one GUI (e.g. GUI 200c or 200d of FIG. 2C or 2D) that includes at least one feature (e.g., feature 202c or 202d of FIG. 2C or 2D) for selecting the user elected fee amount from a plurality of varying fee amounts that are identified or indicated by the at least one GUI (e.g., GUI 200c or 200d).

Turning now to FIG. 6E, in some implementations, the operation may include or involve an operation 623 for transmitting to the one or more client devices the at least one bidding tag that is designed to facilitate the one or more client devices to provide the at least one GUI for soliciting the at least one open bid by transmitting to the one or more client devices at least one bidding tag that is designed to facilitate the one or more client devices to provide at least one GUI for soliciting at least one open bid for accessing the specific content at a predefined amount of content access latency not modifiable by a user. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI for soliciting the at least one open bid 40* by transmitting to the one or more client devices 60* at least one bidding tag 30 that includes data 32 that facilitates the one or more client devices 60* to provide at least one GUI (e.g., GUI 200a or 200c of FIG. 2A or 2B) for soliciting or eliciting at least one open bid 40* for accessing the specific content 20 at a predefined amount of content access latency (see text 203a or 203c of FIG. 2A or 2C) not modifiable by a user 62*.

In various implementations, operation 618 may include an operation 624 for transmitting to the one or more client devices the at least one bidding tag that is designed to facilitate the one or more client devices to provide the at least one GUI for soliciting the at least one open bid by transmitting to the one or more client devices at least one bidding tag that is designed to facilitate the one or more client devices to provide at least one GUI that includes at least one feature for electing at least one user elected amount of content access latency. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI for soliciting the at least one open bid 40* by transmitting (e.g., relaying) to the one or more client devices 60* at least one bidding tag 30 that includes data 32 that facilitates the one or more client devices 60* to provide at least one GUI (e.g., GUI 200b or 200d of FIG. 2B or 2D) that includes at least one feature (e.g., feature 204b or 204d of FIG. 2B or 2D) for electing at least one user elected amount of content access latency.

In some cases, operation 624 may, in turn, include an operation 625 for transmitting to the one or more client devices the at least one bidding tag that is designed to facilitate the one or more client devices to provide the at least one GUI that includes the at least one feature for electing the at least one user elected amount of content access latency by transmitting to the one or more client devices at least one bidding tag that is designed to facilitate the one or more client devices to provide at least one GUI that includes at least one feature for selecting the at least one user elected amount of content access latency from a plurality of varying amounts of preset content access latencies. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI that includes the at least one feature for electing the at least one user elected amount of content access latency by transmitting to the one or more client devices 60* at least one bidding tag 30 that includes data that facilitates the one or more client devices 60* to provide at least one GUI (e.g., GUI 200d of FIG. 2D) that includes at least one feature (e.g., feature 204d) for selecting the at least one user elected amount of content access latency from a plurality of varying amounts of preset content access latencies.

In some implementations, operation 625 may further include an operation 626 for transmitting to the one or more client devices the at least one bidding tag that is designed to facilitate the one or more client devices to provide the at least one GUI that includes the at least one feature for selecting the at least one user elected amount of content access latency from the plurality of varying amounts of preset content access latencies by transmitting to the one or more client devices at least one bidding tag that is designed to facilitate the one or more client devices to provide at least one GUI that includes at least one feature for selecting the at least one user elected amount of content access latency from a plurality of varying amounts of preset content access latencies that are identified by the at least one GUI. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI that includes the at least one feature for selecting the at least one user elected amount of content access latency from the plurality of varying amounts of preset content access latencies by transmitting to the one or more client devices 60* at least one bidding tag 30 that includes data 32 that facilitates the one or more client devices 60* to provide at least one GUI 200d (see FIG. 2D) that includes at least one feature 200d (see FIG. 2D) for selecting the at least one user elected amount of content access latency from a plurality of varying amounts of preset content access latencies that are identified (see feature 200d) by the at least one GUI 200d.

Referring now to FIG. 6F, in some implementations, operation 624 may actually include or involve an operation 627 for transmitting to the one or more client devices the at least one bidding tag that is designed to facilitate the one or more client devices to provide the at least one GUI that includes the at least one feature for electing the at least one user elected amount of content access latency by transmitting to the one or more client devices at least one bidding tag that is designed to facilitate the one or more client devices to provide at least one GUI that includes at least one feature for entering the at least one user elected amount of content access latency. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI that includes the at least one feature for electing the at least one user elected amount of content access latency by transmitting (e.g., relaying) to the one or more client devices 60* at least one bidding tag 30 that includes data that facilitates the one or more client devices 60* to provide at least one GUI 200b (see FIG. 2B) that includes at least one feature 204b (see FIG. 2B) for entering the at least one user elected amount of content access latency.

Referring now to FIG. 6G, in some implementations, the operation 618 may actually include or involve an operation 628 for transmitting to the one or more client devices the at least one bidding tag that is designed to facilitate the one or more client devices to provide the at least one GUI for soliciting the at least one open bid by transmitting to the one or more client devices at least one bidding tag that is designed to facilitate the one or more client devices to provide at least one GUI that includes a first feature for electing at least one user elected fee amount and a second feature for electing at least one user elected amount of content access latency, the user elected fee amount and the user elected amount of content access latency for defining at least one open bid. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI for soliciting the at least one open bid 40* by transmitting (e.g., relaying) to the one or more client devices 60* at least one bidding tag 30 that includes data 32 that facilitates the one or more client devices 60* to provide at least one GUI (e.g., GUI 200b or 200d) that includes a first feature (e.g., feature 200b or 200d of FIG. 2B or 2D) for electing at least one user elected fee amount and a second feature (e.g., feature 204b or 204d of FIG. 2B or 2D) for electing at least one user elected amount of content access latency, the user elected fee amount and the user elected amount of content access latency for defining at least one open bid 40*.

In other implementations, operation 628 may further include or involve an operation 629 for transmitting to the one or more client devices the at least one bidding tag that is designed to facilitate the one or more client devices to provide the at least one GUI that includes the first feature for electing the at least one user elected fee amount and the second feature for electing the at least one user elected amount of content access latency by transmitting to the one or more client devices at least one bidding tag that is designed to facilitate the one or more client devices to provide at least one GUI that includes a first feature for entering the at least one user elected fee amount and a second feature for entering the at least one user elected amount of content access latency. For instance, the bidding tag relaying module 404 of the computing system 10* of FIG. 3A or 3B transmitting to the one or more client devices 60* the at least one bidding tag 30 that is designed to facilitate the one or more client devices to provide the at least one GUI that includes the first feature for electing the at least one user elected fee amount and the second feature for electing the at least one user elected amount of content access latency by transmitting to the one or more client devices 60* at least one bidding tag 30 that includes data 32 that facilitates the one or more client devices 60* to provide at least one GUI 200b (see FIG. 2B) that includes a first feature 202b (see FIG. 2B) for entering the at least one user elected fee amount and a second feature 204b (see FIG. 2B) for entering the at least one user elected amount of content access latency.

In some implementations, operation 628 may alternatively include an operation 630 for transmitting to the one or more client devices the at least one bidding tag that is designed to facilitate the one or more client devices to provide the at least one GUI that includes the first feature for electing the at least one user elected fee amount and the second feature for electing the at least one user elected amount of content access latency by transmitting to the one or more client devices at least one bidding tag that is designed to facilitate the one or more client devices to provide at least one GUI that includes a first feature for selecting the at least one user elected fee amount from a plurality of preset fee amounts that are selectable through the first feature and a second feature for selecting the at least one user elected amount of content access latency from a plurality of varying amounts of preset content access latencies. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI that includes the first feature for electing the at least one user elected fee amount and the second feature for electing the at least one user elected amount of content access latency by transmitting to the one or more client devices 60* at least one bidding tag 30 that includes data 32 that facilitates the one or more client devices 60* to provide at least one GUI 200d (see FIG. 2D) that includes a first feature 202d (see FIG. 2D) for selecting the at least one user elected fee amount from a plurality of preset (e.g., predefined) fee amounts that are selectable through the first feature 202d and a second feature 204d (see FIG. 2D) for selecting the at least one user elected amount of content access latency from a plurality of varying amounts of preset (e.g., predefined) content access latencies.

Turning to FIG. 6H, in various implementations, operation 618 may include or involve an operation 631 for transmitting to the one or more client devices the at least one bidding tag that is designed to facilitate the one or more client devices to provide the at least one GUI for soliciting the at least one open bid by transmitting to the one or more client devices at least one bidding tag that is designed to facilitate the one or more client devices to provide at least one GUI that includes a feature for electing the specific content to be bid on. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI for soliciting the at least one open bid 40* by transmitting (e.g., relaying) to the one or more client devices at least one bidding tag that includes data 32 that facilitates the one or more client devices 60* to provide at least one GUI 200a or 200k (see FIG. 2A or 2K) that includes a feature 212a or 212k (see FIG. 2A or 2K) for electing the specific content 20 to be bid on (e.g., the specific content 20 being offered for consumption).

In some cases, operation 631 may actually include or involve an operation 632 for transmitting to the one or more client devices the at least one bidding tag that is designed to facilitate the one or more client devices to provide the at least one GUI that includes the feature for electing the specific content to be bid on by transmitting to the one or more client devices at least one bidding tag that is designed to facilitate the one or more client devices to provide at least one GUI that includes a feature for entering name of the specific content. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI that includes the feature for electing the specific content 20 to be bid on by transmitting to the one or more client devices 60* at least one bidding tag 30 that includes data 32 that facilitates the one or more client devices 60* to provide at least one GUI 200a (see FIG. 2A) that includes a feature 212a (see FIG. 2A) for entering name (e.g., identifier) of the specific content.

In other cases, operation 631 may alternatively include or involve an operation 633 for transmitting to the one or more client devices the at least one bidding tag that is designed to facilitate the one or more client devices to provide the at least one GUI that includes the feature for electing the specific content to be bid on by transmitting to the one or more client devices at least one bidding tag that is designed to facilitate the one or more client devices to provide at least one GUI that includes a feature for selecting the specific content to be bid on from a plurality of predefined content. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI that includes the feature for electing the specific content 20 to be bid on by transmitting to the one or more client devices 60* at least one bidding tag 30 that includes data 32 that facilitates the one or more client devices 60* to provide at least one GUI 200k (see FIG. 2K) that includes a feature 212k (see FIG. 2K) for selecting the specific content 20 to be bid on from a plurality of predefined content.

Referring to FIG. 6I, in various implementations operation 618 may include or involve an operation 634 for transmitting to the one or more client devices the at least one bidding tag that is designed to facilitate the one or more client devices to provide the at least one GUI for soliciting the at least one open bid by transmitting to the one or more client devices at least one bidding tag that is designed to facilitate the one or more client devices to provide at least one GUI that at least partially identifies the specific content. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI for soliciting the at least one open bid 40* by transmitting (e.g., relaying) to the one or more client devices 60* at least one bidding tag 30 that includes data 32 that facilitates the one or more client devices 60* to provide at least one GUI 200b (see FIG. 2B) that at least partially identifies (e.g., text 212b of FIG. 2B) the specific content 20.

In some implementations, operation 634 may further include or involve an operation 635 for transmitting to the one or more client devices the at least one bidding tag that is designed to facilitate the one or more client devices to provide the at least one GUI that at least partially identifies the specific content by transmitting to the one or more client devices at least one bidding tag that is designed to facilitate the one or more client devices to provide at least one GUI that at least partially identifies the specific content as being at least a particular type of news content. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI that at least partially identifies the specific content 20 by transmitting to the one or more client devices 60* at least one bidding tag 30 that includes data that facilitates the one or more client devices 60* to provide at least one GUI (e.g., GUI 200b, 200c, 200d, 200e, 200f, 200h, or 200i of FIG. 2B, 2C, 2D, 2E, 2F, 2H, or 2I) that at least partially identifies the specific content 20 as being at least a particular type of news content (e.g., financial or market news such as news about price of a particular stock or commodity, celebrity news, regulatory news, and so forth).

In some alternative implementations, operation 634 may alternatively include or involve an operation 636 for transmitting to the one or more client devices the at least one bidding tag that is designed to facilitate the one or more client devices to provide the at least one GUI that at least partially identifies the specific content by transmitting to the one or more client devices at least one bidding tag that is designed to facilitate the one or more client devices to provide at least one GUI that at least partially identifies the specific content as being at least a particular consumable media. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI that at least partially identifies the specific content 20 by transmitting to the one or more client devices 60* at least one bidding tag 30 that includes data 32 that facilitates the one or more client devices 60* to provide at least one GUI (e.g., GUI 200g or 200m of FIG. 2G or 2M) that at least partially identifies the specific content 20 as being at least a particular consumable media (e.g., a particular movie, a digital novel, a recording of a sporting event, and so forth).

Referring now to FIG. 6J, in various implementations, operation 618 may include an operation 637 for transmitting to the one or more client devices the at least one bidding tag that is designed to facilitate the one or more client devices to provide the at least one GUI for soliciting the at least one open bid by transmitting to the one or more client devices at least one bidding tag that is designed to facilitate the one or more client devices to provide at least one GUI that provides access to contextual information related to the specific content. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI for soliciting the at least one open bid 40* by transmitting (e.g., relaying) to the one or more client devices 60* at least one bidding tag 30 that includes data 32 that facilitates the one or more client devices 60* to provide at least one GUI (e.g., GUI 200a of FIG. 2A) that provides access to contextual information 24 (e.g., historical or general background information related to the specific content 20, movie trailers related to the specific content 20, and so forth) related to the specific content 20.

As further illustrated in FIG. 6J, in some implementations, operation 637 may further include an operation 638 for transmitting to the one or more client devices the at least one bidding tag that is designed to facilitate the one or more client devices to provide the at least one GUI that provides access to the contextual information related to the specific content by transmitting to the one or more client devices at least one bidding tag that is designed to facilitate the one or more client devices to provide at least one GUI that provides an option for retrieving and/or presenting the contextual information related to the specific content. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI that provides access to the contextual information 24 related to the specific content 20 by transmitting to the one or more client devices 60* at least one bidding tag 30 that includes data 32 that facilitates the one or more client devices 60* to provide at least one GUI (e.g., GUI 200a of FIG. 2A) that provides an option (feature 208a of FIG. 2A) for retrieving and/or presenting the contextual information 24 related to the specific content. For example, in the example GUI 200a of FIG. 2A, feature 208a is provided that can be “clicked” by a user 62* in order to retrieve/display contextual information 24 that is in the form of historical background information.

In some alternative implementations, operation 637 may alternatively include an operation 639 for transmitting to the one or more client devices the at least one bidding tag that is designed to facilitate the one or more client devices to provide the at least one GUI that provides access to the contextual information related to the specific content by transmitting to the one or more client devices at least one bidding tag that is designed to facilitate the one or more client devices to provide at least one GUI that shows the contextual information related to the specific content. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI that provides access to the contextual information 24 related to the specific content 20 by transmitting to the one or more client devices 60* at least one bidding tag that includes data 32 that facilitates the one or more client devices 60* to provide at least one GUI (e.g., GUI 200b) that shows (see text 209b of FIG. 2B) the contextual information 24 related to the specific content 20.

In some implementations, operation 637 may actually involve an operation 640 for transmitting to the one or more client devices the at least one bidding tag that is designed to facilitate the one or more client devices to provide the at least one GUI that provides access to the contextual information related to the specific content by transmitting to the one or more client devices at least one bidding tag that is designed to facilitate the one or more client devices to provide at least one GUI that provides access to historical background information related to the specific content as illustrated in FIG. 6K. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI that provides access to the contextual information 24 related to the specific content 20 by transmitting to the one or more client devices 60* at least one bidding tag 30 that includes data 32 that facilitates the one or more client devices 60* to provide at least one GUI (e.g., GUI 200a or 200b of FIG. 2A or 2B) that provides access (e.g., feature 208a of FIG. 2A for retrieving historical information or text 209b of FIG. 2b) to historical background information related to the specific content 20.

In some alternative implementations, operation 637 may actually involve an operation 641 for transmitting to the one or more client devices the at least one bidding tag that is designed to facilitate the one or more client devices to provide the at least one GUI that provides access to the contextual information related to the specific content by transmitting to the one or more client devices at least one bidding tag that is designed to facilitate the one or more client devices to provide at least one GUI that provides access to one or more movie trailers related to the specific content. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI that provides access to the contextual information 24 related to the specific content 20 by transmitting to the one or more client devices 60* at least one bidding tag 30 that includes data 32 that facilitates the one or more client devices 60* to provide at least one GUI (e.g., GUI 200m of FIG. 2M) that provides access (e.g., feature 208m, which may be “clicked” by a user 62*) to one or more movie trailers related to the specific content 20 (e.g., a movie).

Turning now to FIG. 6L, in various implementations, operation 618 may include or involve an operation 642 for transmitting to the one or more client devices the at least one bidding tag that is designed to facilitate the one or more client devices to provide the at least one GUI for soliciting the at least one open bid by transmitting to the one or more client devices at least one bidding tag that is designed to facilitate the one or more client devices to provide at least one GUI that provides access to previous consumer information related to one or more users who have previously accessed the specific content. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI for soliciting the at least one open bid 40* by transmitting (e.g., relaying) to the one or more client devices 60* at least one bidding tag 30 that includes data 32 that facilitates the one or more client devices 60* to provide at least one GUI (e.g., GUI 200a or 200b of FIG. 2A or 2B) that provides access to previous consumer information 22 related to one or more users 62* who have previously accessed the specific content 20.

As further illustrated in FIG. 6L, in some implementations, operation 642 may further include an operation 643 for transmitting to the one or more client devices the at least one bidding tag that is designed to facilitate the one or more client devices to provide the at least one GUI that provides access to the previous consumer information related to the one or more users who have previously accessed the specific content by transmitting to the one or more client devices at least one bidding tag that is designed to facilitate the one or more client devices to provide at least one GUI that provides an option for retrieving and/or presenting the previous consumer information. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI that provides access to the previous consumer information 22 related to the one or more users 62* who have previously accessed the specific content 20 by transmitting to the one or more client devices 60* at least one bidding tag 30 that includes data 32 that facilitates the one or more client devices 60* to provide at least one GUI 200a (see FIG. 2A) that provides an option (e.g., feature 210a of FIG. 2A, which may be “clicked” by a user 62*) for retrieving and/or presenting the previous consumer information 22.

In some alternative implementations, operation 642 may alternatively include an operation 644 for transmitting to the one or more client devices the at least one bidding tag that is designed to facilitate the one or more client devices to provide the at least one GUI that provides access to the previous consumer information related to the one or more users who have previously accessed the specific content by transmitting to the one or more client devices at least one bidding tag that is designed to facilitate the one or more client devices to provide at least one GUI that shows the previous consumer information. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI that provides access to the previous consumer information 22 related to the one or more users 62* who have previously accessed the specific content 20 by transmitting to the one or more client devices 60* at least one bidding tag 30 that includes data 32 that facilitates the one or more client devices 60* to provide at least one GUI 200b (see FIG. 2B) that shows (see text 211b of FIG. 2B) the previous consumer information 22.

In some implementations, operation 642 may include or involve an operation 645 for transmitting to the one or more client devices the at least one bidding tag that is designed to facilitate the one or more client devices to provide the at least one GUI that provides access to the previous consumer information related to the one or more users who have previously accessed the specific content by transmitting to the one or more client devices at least one bidding tag that is designed to facilitate the one or more client devices to provide at least one GUI that provides access to previous consumer information that identifies the one or more users who have previously accessed the specific content and/or the number of one or more users who have previously accessed the specific content as illustrated in FIG. 6M. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI that provides access to the previous consumer information 22 related to the one or more users 62* who have previously accessed the specific content 20 by transmitting to the one or more client devices 60* at least one bidding tag 30 that includes data 32 that facilitates the one or more client devices 60* to provide at least one GUI (e.g., GUI 200a or 200b of FIG. 2A or 2B) that provides access to previous consumer information 22 that identifies the one or more users 62* who have previously accessed the specific content 20 and/or the number of one or more users 62* who have previously accessed the specific content 20.

In the same or alternative implementations, operation 642 may additionally or alternatively include or involve an operation 646 for transmitting to the one or more client devices the at least one bidding tag that is designed to facilitate the one or more client devices to provide the at least one GUI that provides access to the previous consumer information related to the one or more users who have previously accessed the specific content by transmitting to the one or more client devices at least one bidding tag that is designed to facilitate the one or more client devices to provide at least one GUI that provides access to previous consumer information that indicates when and/or how the one or more users who have previously accessed the specific content actually accessed the specific content. For instance, the bidding tag relaying module 404 of the computing system 10* of FIG. 3A or 3B transmitting to the one or more client devices 60* the at least one bidding tag 30 that is designed to facilitate the one or more client devices 60* to provide the at least one GUI that provides access to the previous consumer information 22 related to the one or more users 62* who have previously accessed the specific content 20 by transmitting to the one or more client devices 60* at least one bidding tag 30 that includes data 32 that facilitates the one or more client devices 60* to provide at least one GUI (e.g., GUI 200a of FIG. 2A) that provides access (e.g., feature 210a of FIG. 2A, which may be “clicked” by a user 62*) to previous consumer information 22 that indicates when and/or how (e.g., the network used to access) the one or more users 62* who have previously accessed the specific content 20 actually accessed the specific content 20.

Referring now to FIG. 6N, in various implementations, operation 618 may include or involve an operation 647 for transmitting to the one or more client devices at least one bidding tag that is designed to facilitate the one or more client devices to provide at least one GUI that includes a first feature for electing a first user elected fee amount for a first content access latency and a second feature for electing a second user elected fee amount for a second content access latency. For instance, the bidding tag relaying module 404 of the computing system 10* of FIG. 3A or 3B transmitting (e.g., relaying) to the one or more client devices 60* at least one bidding tag 30 that includes data 32 that facilitates the one or more client devices 60* to provide at least one GUI 200e or 200f (see FIG. 2E or 2F) that includes a first feature 221e or 221f (see FIG. 2E or 2F) for electing a first user elected fee amount for a first content access latency and a second feature 222e or 222f (see FIG. 2E or 2F) for electing a second user elected fee amount for a second content access latency.

As further illustrated in FIG. 6N, in various implementations operation 647 may include one or more additional operations including, in some cases, an operation 648 for transmitting to the one or more client devices at least one bidding tag that is designed to facilitate the one or more client devices to provide at least one GUI that includes a first feature for electing a first user elected fee amount for a first user elected content access latency and a second feature for electing a second user elected fee amount for a second user elected content access latency. For instance, the bidding tag relaying module 404 of the computing system 10* of FIG. 3A or 3B transmitting to the one or more client devices 60* at least one bidding tag 30* that includes data 32 that facilitates the one or more client devices 60* to provide at least one GUI 200e (see FIG. 2E) that includes a first feature 221e (see FIG. 2E) for electing a first user elected fee amount for a first user elected content access latency (see feature 231e for entering a user elected content access latency) and a second feature 222e for electing a second user elected fee amount for a second user elected content access latency (see feature 232e).

In some implementations, operation 647 may actually include or involve an operation 649 for transmitting to the one or more client devices at least one bidding tag that is designed to facilitate the one or more client devices to provide at least one GUI that includes the first feature for electing the first user elected fee amount for the first content access latency, the second feature for electing the second user elected fee amount for the second content access latency, and a third feature for electing a third user elected fee amount for a third content access latency. For instance, the bidding tag relaying module 404 of the computing system 10* of FIG. 3A or 3B transmitting to the one or more client devices 60* at least one bidding tag 30 that includes data 32 that facilitates the one or more client devices 60* to provide at least one GUI 200e or 200f (see FIG. 2E or 2F) that includes the first feature 221e or 221f (see FIG. 2E or 2F) for electing the first user elected fee amount for the first content access latency, the second feature 222e or 222f (see FIG. 2E or 2F) for electing the second user elected fee amount for the second content access latency, and a third feature 223e or 223f (see FIG. 2E or 2F) for electing a third user elected fee amount for a third content access latency.

As further illustrated in FIG. 6N, in some cases, operation 649 may further include an operation 650 for transmitting to the one or more client devices at least one bidding tag that is designed to facilitate the one or more client devices to provide at least one GUI that includes a first feature for electing a first user elected fee amount for a first user elected content access latency, a second feature for electing a second user elected fee amount for a second user elected content access latency, and a third feature for electing a third user elected fee amount for a third user elected content access latency. For instance, the bidding tag relaying module 404 of the computing system 10* of FIG. 3A or 3B transmitting to the one or more client devices 60* at least one bidding tag 30 that includes data 32 that facilitates the one or more client devices 60* to provide at least one GUI 200e (see FIG. 2E) that includes a first feature 221e (see FIG. 2E) for electing a first user elected fee amount for a first user elected content access latency (see feature 231e of FIG. 2E), a second feature 222e for electing a second user elected fee amount for a second user elected content access latency (see feature 232e of FIG. 2E), and a third feature 223e for electing a third user elected fee amount for a third user elected content access latency (see feature 233e of FIG. 2E).

Turning now to FIG. 6P, in various implementations, the open bid acquiring operation 502 may include an operation 651 for acquiring the plurality of open bids for the one or more content access latencies by acquiring a first open bid indicating a first offer amount for a first content access latency and a second open bid indicating a second offer amount for a second content access latency, the first content access latency being different from the second content access latency. For instance, the open bid obtaining module 102* of the computing system 10* of FIG. 3A or 3B acquiring the plurality of open bids 40* for the one or more content access latencies by acquiring (e.g., obtaining) a first open bid 40a (see FIG. 1) indicating a first offer amount for a first content access latency and a second open bid 40b indicating a second offer amount for a second content access latency, the first content access latency being different from the second content access latency. For example, different users 62* may submit different open bids 40* for different content access latencies.

As further illustrated in FIG. 6P, operation 651 may include one or more additional operations in various alternative implementations including, in some implementations, an operation 652 for acquiring the first open bid indicating the first offer amount for the first content access latency and the second open bid indicating the second offer amount for the second content access latency by acquiring a first open bid that was submitted by a first user and a second open bid that was submitted by a second user. For instance, the open bid obtaining module 102* of the computing system 10* of FIG. 3A or 3B acquiring the first open bid 40a (see FIG. 1) indicating the first offer amount for the first content access latency and the second open bid 40b indicating the second offer amount for the second content access latency by acquiring a first open bid 40a that was submitted by a first user 62a and a second open bid 40b that was submitted by a second user 62b.

In some implementations, operation 651 may include an operation 653 for acquiring the first open bid indicating the first offer amount for the first content access latency and the second open bid indicating the second offer amount for the second content access latency by acquiring further a third open bid for a third offer amount for a third content access latency that is different from the first or the second content latencies. For instance, the open bid obtaining module 102* of the computing system 10* of FIG. 3A or 3B acquiring the first open bid 40a indicating the first offer amount for the first content access latency and the second open bid 40b indicating the second offer amount for the second content access latency by acquiring (e.g., obtaining) further a third open bid 40c for a third offer amount for a third content access latency that is different from the first or the second content latencies.

In various implementations, operation 653 may include one or more additional operations including, in some cases, an operation 654 for acquiring the first open bid, the second open bid, and the third open bid by acquiring a first bid that was submitted by a first user, a second bid that was submitted by a second user, and a third bid submitted by a third user. For instance, the open bid obtaining module 102* of the computing system 10* of FIG. 3A or 3B acquiring the first open bid 40a, the second open bid 40b, and the third open bid 40c by acquiring a first bid 40a that was submitted by a first user 62a, a second bid 40b that was submitted by a second user 62b, and a third bid 40c submitted by a third user 62c.

In some implementations, operation 653 may further include an operation 655 for acquiring the first open bid indicating the first offer amount for the first content access latency, the second open bid indicating the second offer amount for the second content access latency, and the third open bid indicating the third offer amount for the third content access latency by acquiring further a fourth open bid indicating a fourth offer amount for a fourth content access latency that is different from the first, the second, or the third content latencies. For instance, the open bid obtaining module 102* of the computing system 10* of FIG. 3A or 3B acquiring the first open bid 40a indicating the first offer amount for the first content access latency, the second open bid 40b indicating the second offer amount for the second content access latency, and the third open bid 40c indicating the third offer amount for the third content access latency by acquiring further a fourth open bid 40d indicating a fourth offer amount for a fourth content access latency that is different from the first, the second, or the third content latencies.

In some cases, operation 655 may further include an operation 656 for acquiring the first open bid, the second open bid, the third open bid, and the fourth open bid by acquiring a first open bid that was submitted by a first user, a second open bid that was submitted by a second user, a third open bid submitted by a third user, and a fourth open bid that was submitted by a fourth user. For instance, the open bid obtaining module 102* of the computing system 10* of FIG. 3A or 3B acquiring the first open bid 40a, the second open bid 40b, the third open bid 40c, and the fourth open bid 40d by acquiring a first open bid 40a that was submitted by a first user 62a, a second open bid 40b that was submitted by a second user 62b, a third open bid 40c submitted by a third user 62c, and a fourth open bid 40d that was submitted by a fourth user 62d.

Referring now to FIG. 6Q, in various implementations, the open bid acquiring operation 502 may include an operation 657 for acquiring the plurality of open bids for the one or more content access latencies by acquiring a first open bid submitted by a first user that indicates a first offer amount for a specific content access latency and a second open bid submitted by a second user that indicates a second offer amount for the specific content access latency. For instance, the open bid obtaining module 102* of the computing system 10* of FIG. 3A or 3B acquiring the plurality of open bids 40* for the one or more content access latencies by acquiring (e.g., obtaining) a first open bid 40a submitted by a first user 62a that indicates a first offer amount for a specific content access latency and a second open bid 40b submitted by a second user 62b that indicates a second offer amount for the specific content access latency. Note that although operation 657 appears to be similar to operation 651, they are, in fact, distinct. That is, operation 651 is directed to an implementation whereby multiple open bids 40* for different content access latencies are acquired while operation 657 is directed to an implementation whereby multiple open bids 40* for the same content access latency (e.g., when multiple users 62* are bidding for the same content access latency such as the smallest or lowest content access latency) are acquired.

As further illustrated in FIG. 6Q, operation 657 may include one or more additional operations in various alternative implementations including, in some cases, an operation 658 for acquiring the first open bid submitted by the first user that indicates the first offer amount for the specific content access latency and the second open bid submitted by the second user that indicates the second offer amount for the specific content access latency by acquiring a first open bid submitted by the first user that indicates a first offer amount for the specific content access latency and a second open bid submitted by the second user that indicates a second offer amount for the specific content access latency, the first offer amount and the second offer amount being different offer amounts. For instance, the open bid obtaining module 102* of the computing system 10* of FIG. 3A or 3B acquiring the first open bid 40a submitted by the first user 62a that indicates the first offer amount for the specific content access latency and the second open bid 40b submitted by the second user 62b that indicates the second offer amount for the specific content access latency by acquiring a first open bid 40a submitted by the first user 62a that indicates a first offer amount for the specific content access latency and a second open bid 40b submitted by the second user 62b that indicates a second offer amount for the specific content access latency, the first offer amount and the second offer amount being different offer amounts.

In the same or alternative implementations, operation 657 may include or involve an operation 659 for acquiring the first open bid and the second open bid by acquiring further a third open bid submitted by a third user that indicates a third offer amount for the specific content access latency. For instance, the open bid obtaining module 102* of the computing system 10* of FIG. 3A or 3B acquiring the first open bid 40a and the second open bid 40b by acquiring (e.g., obtaining) further a third open bid 40c submitted by a third user 62c that indicates a third offer amount for the specific content access latency.

In some implementations, operation 659 may further include or involve an operation 660 for acquiring the third open bid submitted by the third user that indicates the third offer amount for the specific content access latency, the third offer amount being different from the first offer amount and/or the second offer amount. For instance, the open bid obtaining module 102* of the computing system 10* of FIG. 3A or 3B acquiring the third open bid 40c submitted by the third user 62c that indicates the third offer amount for the specific content access latency, the third offer amount being different from the first offer amount and/or the second offer amount.

In some implementations, operation 659 may further include or involve an operation 661 for acquiring the first open bid, the second open bid, and the third open bid by acquiring further a fourth open bid submitted by a fourth user that indicates a fourth offer amount for the specific content access latency. For instance, the open bid obtaining module 102* of the computing system 10* of FIG. 3A or 3B acquiring the first open bid 40a, the second open bid 40b, and the third open bid 40c by acquiring further a fourth open bid 40d submitted by a fourth user 62d that indicates a fourth offer amount for the specific content access latency.

As further illustrated in FIG. 6Q, in some cases, operation 661 may further include an operation 662 for acquiring the fourth open bid submitted by the fourth user that indicates the fourth offer amount for the specific content access latency, the fourth offer amount being different from the first offer amount, the second offer amount, and/or the third offer amount. For instance, the open bid obtaining module 102* of the computing system 10* of FIG. 3A or 3B acquiring the fourth open bid 40d submitted by the fourth user 62d that indicates the fourth offer amount for the specific content access latency, the fourth offer amount being different from the first offer amount, the second offer amount, and/or the third offer amount.

Referring back to the highest offer amount open bid determining operation 504 of FIG. 5, the highest offer amount open bid determining operation 504 similar to the open bid acquiring operation 502 of FIG. 5 may be executed in a number of different ways in various alternative embodiments as illustrated in FIGS. 7A and 7B. In some implementations, for example, the highest offer amount open bid determining operation 504 of FIG. 5 may include an operation an operation 763 for determining which one or more of the plurality of open bids indicate at least the highest offer amount by comparing the open bids with respect to each other in order to determine which of one or more of the plurality of open bids indicate the highest offer amount. For instance, the highest offer amount open bid ascertaining module 104* including the open bid comparing module 406 (see FIG. 4B) of the computing system 10* of FIG. 3A or 3B determining which one or more of the plurality of open bids 40* indicate at least the highest offer amount when the open bid comparing module 406 compares the open bids 40*with respect to each other in order to determine which of one or more of the plurality of open bids 40* indicate the highest offer amount.

In the same or alternative implementations, the highest offer amount open bid determining operation 504 may additionally or alternatively include an operation 764 for determining which one or more of the plurality of open bids indicate the highest offer amount by determining which two or more of the plurality of open bids indicate the highest offer amount. For instance, the highest offer amount open bid ascertaining module 104* of the computing system 10* of FIG. 3A or 3B determining which one or more of the plurality of open bids 40* indicate the highest offer amount by determining (e.g., ascertaining) which two or more of the plurality of open bids 40* indicate the highest offer amount. For example, a plurality of open bids 40* that were obtained may be considered the highest bids by offering the same or similar highest offer amount or amounts.

In the same or alternative implementations, the highest offer amount open bid determining operation 504 may additionally or alternatively include an operation 765 for determining which one or more of the plurality of open bids indicate the highest offer amount including determining which of the one or more of the plurality of open bids indicate the highest offer amount, and determining which of the plurality of users submitted the one or more open bids that were determined to indicate the highest offer amount. For instance, the highest offer amount open bid ascertaining module 104* including the user ascertaining module 408 (see FIG. 4B) of the computing system 10* of FIG. 3A or 3B determining which one or more of the plurality of open bids 40* indicate the highest offer amount including determining which of the one or more of the plurality of open bids 40* indicate the highest offer amount, and determining or ascertaining, by the user ascertaining module 408, as to which one or more of the plurality of users 62* submitted the one or more open bids 40* that were determined or ascertained to indicate the highest offer amount.

In the same or alternative implementations, the highest offer amount open bid determining operation 504 may additionally or alternatively include an operation 766 for determining which one or more of the plurality of open bids indicate the highest offer amount by determining which one or more of the plurality of open bids indicate the highest offer amount or amounts amongst the plurality of open bids and determining which one or more of the plurality of open bids indicate the second highest offer amount or amounts amongst the plurality of open bids. For instance, the highest offer amount open bid ascertaining module 104* of the computing system 10* of FIG. 3A or 3B determining which one or more of the plurality of open bids 40* indicate the highest offer amount by determining (e.g., ascertaining) which one or more of the plurality of open bids 40* indicate the highest offer amount or amounts (e.g., top five amounts) amongst the plurality of open bids 40* and determining (e.g., ascertaining) which one or more of the plurality of open bids 40* indicate the second highest offer amount or amounts amongst the plurality of open bids (e.g., 5th through the 10th highest amounts). Based, at least in part, on such a determination, the users 62* who submitted the highest open bids 40* (e.g., the open bids 40* that indicate highest offer amounts), in some implementations, may be provided earliest access (e.g., smallest content access latency) to the specific content 20 while those users 62* who submitted the second highest open bids 40* (e.g., the open bids 40* that indicate the second highest offer amounts) may be provided second earliest access (e.g., second lowest content access latency) to the specific content 20.

In some cases, operation 766 may further include or involve an operation 767 for determining which one or more of the plurality of open bids indicate the second highest offer amount or amounts for the specific content access latency by determining further which one or more of the plurality of open bids indicate the third highest offer amount or amounts amongst the plurality of open bids. For instance, the highest offer amount open bid ascertaining module 104* of the computing system 10* of FIG. 3A or 3B determining which one or more of the plurality of open bids 40* indicate the second highest offer amount or amounts for the specific content access latency by determining further which one or more of the plurality of open bids 40* indicate the third highest offer amount or amounts amongst the plurality of open bids 40*. For example, determining which of the plurality of open bids 40* indicate the top three highest offer amounts, determining which of the plurality of open bids 40* indicate the fourth through the sixth highest offer amounts, and then determining which of the plurality of open bids 40* indicate the seventh through the ninth highest offer amounts. Based on such determinations, users 62* associated with each of the determined groups of open bids 40* (e.g., the top three open bids 40*, the second three open bids 40*, and so forth) may be provided with the specific content with different amounts of content access latencies.

Referring now to FIG. 7B, in various implementations, the highest offer amount open bid determining operation 504 may additionally or alternatively include an operation 768 for determining which one or more of the plurality of open bids indicate the highest offer amount amongst the plurality of open bids by determining which one or more of a plurality of open bids for a specific content access latency indicate the highest offer amount or amounts amongst the plurality of open bids for the specific content access latency. For instance, the highest offer amount open bid ascertaining module 104* of the computing system 10* of FIG. 3A or 3B determining which one or more of the plurality of open bids 40* indicate the highest offer amount amongst the plurality of open bids 40* by determining (e.g., ascertaining) which one or more of a plurality of open bids 40* for a specific content access latency (e.g., smallest content access latency such as 1 microsecond) indicate the highest offer amount or amounts amongst the plurality of open bids 40* for the specific content access latency.

In some implementations, operation 768 may further include or involve an operation 769 for determining which one or more of the plurality of open bids for the specific content access latency indicate the highest offer amount or amounts for the specific content access latency by determining further which one or more of a plurality of open bids for a second content access latency indicate the highest offer amount or amounts amongst the plurality of open bids for the second content access latency, the specific content access latency being a first content access latency. For instance, the highest offer amount open bid ascertaining module 104* of the computing system 10* of FIG. 3A or 3B determining which one or more of the plurality of open bids 40* for the specific content access latency indicate the highest offer amount or amounts for the specific content access latency by determining further which one or more of a plurality of open bids 40* for a second content access latency indicate the highest offer amount or amounts amongst the plurality of open bids 40* for the second content access latency, the specific content access latency being a first content access latency.

As further illustrated in FIG. 7B, in some cases, operation 769 may, in turn, further include an operation 770 for determining which one or more of the plurality of open bids for a second content access latency indicate the highest offer amount or amounts amongst the plurality of open bids for the second content access latency by determining further which one or more of a plurality of open bids for a third content access latency indicate the highest offer amount or amounts amongst the plurality of open bids for the third content access latency. For instance, the highest offer amount open bid ascertaining module 104* of the computing system 10* of FIG. 3A or 3B determining which one or more of the plurality of open bids 40* for a second content access latency indicate the highest offer amount or amounts amongst the plurality of open bids 40* for the second content access latency by determining further which one or more of a plurality of open bids 40* for a third content access latency indicate the highest offer amount or amounts amongst the plurality of open bids 40* for the third content access latency.

In various implementations, the highest offer amount open bid determining operation 504 may additionally or alternatively include an operation 771 for determining which one or more of the plurality of open bids indicate at least the highest offer amount amongst the plurality of open bids including determining which one or more of the plurality of open bids indicate the lowest offer amount amongst the plurality of open bids. For instance, the highest offer amount open bid ascertaining module 104* including the lowest offer amount open bid ascertaining module 410 (see FIG. 4B) of the computing system 10* of FIG. 3A or 3B determining which one or more of the plurality of open bids 40* indicate at least the highest offer amount amongst the plurality of open bids 40* including determining or ascertaining, by the lowest offer amount open bid ascertaining module 410, which one or more of the plurality of open bids 40* indicate the lowest offer amount amongst the plurality of open bids 40*. For example, determining the bottom ten open bids 40* with the ten lowest offer amount or amounts.

In some implementations, the highest offer amount open bid determining operation 504 may additionally or alternatively include an operation 772 for determining which one or more of the plurality of open bids indicate at least the highest offer amount amongst the plurality of open bids by ranking the plurality of open bids from one or more open bids that indicate the highest offer amount from amongst the plurality of open bids to one or more open bids that indicate the lowest offer amount from amongst the plurality of open bids. For instance, the highest offer amount open bid ascertaining module 104* including the open bid ranking module 412 (see FIG. 4B) of the computing system 10* of FIG. 3A or 3B determining which one or more of the plurality of open bids 40* indicate at least the highest offer amount amongst the plurality of open bids 40* when the open bid ranking module 412 ranks the plurality of open bids 40* from one or more open bids 40* that indicate the highest offer amount from amongst the plurality of open bids 40* to one or more open bids 40* that indicate the lowest offer amount from amongst the plurality of open bids 40*.

In some implementations, the highest offer amount open bid determining operation 504 may additionally or alternatively include an operation 773 for determining which one or more of the plurality of open bids indicate at least the highest offer amount amongst the plurality of open bids including determining which of two or more of the plurality of open bids indicate the highest offer amount and determining which of the two or more of the plurality of open bids that were determined to indicate the highest offer amount was acquired first. For instance, the highest offer amount open bid ascertaining module 104* of the computing system 10* of FIG. 3A or 3B determining which one or more of the plurality of open bids 40* indicate at least the highest offer amount amongst the plurality of open bids 40* including determining or ascertaining which of two or more of the plurality of open bids 40* indicate the highest offer amount and determining or ascertaining which of the two or more of the plurality of open bids 40* that were determined to indicate the highest offer amount was acquired first. Such a determination, in some cases, may be used as a tie breaker in order to determine which user 62* gets, for example, the lowest or lower access latency when multiple users 62* submit open bids 40* offering the same fee amounts.

Referring back to the content access providing operation 506 of FIG. 5, the content access providing operation 506 similar to the open bid acquiring operation 502 and the highest offer amount open bid determining operation 504 of FIG. 5 may be executed in a number of different ways in various alternative embodiments as illustrated in FIGS. 8A, 8B, 8C, and 8D. In some implementations, for example, the highest offer content access providing operation 506 of FIG. 5 may include an operation an operation 874 for providing at least the access to the specific content to the one or more of the plurality of users by providing at least the access to the specific content to one or more client devices associated with the one or more of the plurality of users in accordance, at least in part, with the determining as illustrated in FIG. 8A. For instance, the content access releasing module 106* of the computing system 10* of FIG. 3A or 3B providing at least the access to the specific content 20 to the one or more of the plurality of users 62* by providing (e.g., releasing) at least the access to the specific content 20 to one or more client devices 60* associated with the one or more of the plurality of users 62* in accordance, at least in part, with the determining or ascertaining which of the one or more of the plurality of open bids 40* indicate at least the highest offer amount amongst the plurality of open bids 40*.

As further illustrated in FIG. 8A, operation 874 may, in turn, further include or involve an operation 875 for providing at least the access to the specific content to the one or more clients devices by transmitting the specific content to the one or more client devices. For instance, the content access releasing module 106* including the content relaying module 414 (see FIG. 4C) of the computing system 10* of FIG. 3A or 3B providing at least the access to the specific content 20 to the one or more clients devices 60* when the content relaying module 414 transmits or relays the specific content 20 to the one or more client devices 60*.

In some implementations, operation 874 may alternatively include or involve an operation 876 for providing at least the access to the specific content to the one or more clients devices by transmitting a link for accessing the content to the one or more client devices. For instance, the content access releasing module 106* including the link relaying module 416 (see FIG. 4C) of the computing system 10* of FIG. 3A or 3B providing at least the access to the specific content 20 to the one or more clients devices 60* when the link relaying module 416 transmits or relays a link (e.g., a hyperlink) for accessing the content 20 to the one or more client devices 60*.

In some implementations, the highest offer content access providing operation 506 may include an operation 877 for providing at least the access to the specific content to the one or more of the plurality of users in accordance, at least in part, with the determining by providing at least access to the specific content to a first one or more users following lapse of a first content access latency and providing at least access to the specific content to a second one or more users following lapse of a second content access latency, the lapse of the first content access latency and the lapse of the second content access latency occurring following a particular point in time, and the first content access latency being less than the second content access latency. For instance, the content access releasing module 106* of the computing system 10* of FIG. 3A or 3B providing at least the access to the specific content 20 to the one or more of the plurality of users 62* in accordance, at least in part, with the determining by providing (e.g., releasing) at least access to the specific content 20 to a first one or more users (e.g., user 62a and user 62d in FIG. 1) following lapse of a first content access latency and providing (e.g., releasing) at least access to the specific content 20 to a second one or more users (e.g., user 62b of FIG. 1) following lapse of a second content access latency, the lapse of the first content access latency and the lapse of the second content access latency occurring following a particular point in time (e.g., an arbitrary point in time such as a content release date/time or the earliest point in time that the specific content 20 can be made accessible), and the first content access latency being less than the second content latency. Note that the phrase “latency” is in reference to a particular time delay or increment. Thus, the phrase “latency.” in some embodiments, may only be relevant if it relates to a defined starting pointing such as a “particular point in time.” Thus, the phrase “the lapse of the first content access latency and the lapse of the second content occurring following a particular point in time” as stated above is in reference to the “latency clock” starting at some common point in time (e.g., “a particular point in time”) such as the earliest point in time that a specific content 20 can be made accessible. That is, different amounts of latencies may not have much meaning unless the different latencies have the same “starting point in time.” For example, if two different latencies have different starting points in time, then it may be possible that both latencies lapse at the same time if the longer latency has an earlier “starting point” in time.

In some implementations, operation 877 may further include an operation 878 for providing at least the access to the specific content to the first one or more users following lapse of the first content access latency and providing at least the access to the specific content to the second one or more users following lapse of the second content access latency, the first one or more users determined to have submitted one or more open bids that were determined to have indicated highest offer amount or amounts amongst the plurality of open bids and the second one or more users determined to have submitted one or more open bids that were determined to have indicated second highest offer amount or amounts amongst the plurality of open bids. For instance, the content access releasing module 106* of the computing system 10* of FIG. 3A or 3B providing (releasing) at least the access to the specific content 20 to the first one or more users (e.g., users 60a and 60d) following lapse of the first content access latency and providing (e.g., releasing) at least the access to the specific content 20 to the second one or more users (e.g., user 62b) following lapse of the second content access latency, the first one or more users (e.g., users 62a and 62d) determined to have submitted one or more open bids (e.g., open bids 40a and 40d) that were determined or ascertained by the highest offer amount open bid ascertaining module 104* to have indicated highest offer amount or amounts amongst the plurality of open bids 40* and the second one or more users (e.g., user 62b) determined to have submitted one or more open bids (e.g., open bid 40b) that were determined or ascertained by the highest offer amount open bid ascertaining module 104* to have indicated second highest offer amount or amounts amongst the plurality of open bids 40*. In some embodiments, operation 879 may capture the situation where bidders (e.g., users 62*) are provided particular content access latencies based on the open bids 40* submitted by the bidders. For example, the highest bidders (e.g., users 62* who submit the highest open bids 40* with the highest offer amounts) being provided with the lowest content access latencies, the second highest bidders being provided with the second highest content access latencies, and so forth.

In some implementations, operation 877 may actually include or involve an operation 879 for providing at least the access to the specific content to the first one or more users following lapse of the first content access latency and providing at least the access to the specific content to the second one or more users following lapse of the second content access latency, the first one or more users determined to have submitted one or more open bids that were determined to have indicated highest offer amount or amounts amongst a plurality of open bids for the first content access latency and the second one or more users determined to have submitted one or more open bids that were determined to have indicated highest offer amount or amounts amongst a plurality of open bids for the second content access latency. For instance, the content access releasing module 106* of the computing system 10* of FIG. 3A or 3B providing (e.g., releasing) at least the access to the specific content 20 to the first one or more users (e.g., users 62a and 62d of FIG. 1) following lapse of the first content access latency and providing (e.g., releasing) at least the access to the specific content 20 to the second one or more users (e.g., user 62b) following lapse of the second content access latency, the first one or more users (e.g., users 62a and 62d) determined to have submitted one or more open bids (e.g., open bids 40a and 40d) that were determined or ascertained by the highest offer amount open bid ascertaining module 104* to have indicated highest offer amount or amounts amongst a plurality of open bids 40* for the first content access latency and the second one or more users (e.g., user 62b) determined to have submitted one or more open bids (e.g., open bid 40b) that were determined or ascertained the highest offer amount open bid ascertaining module 104* to have indicated highest offer amount or amounts amongst a plurality of open bids for the second content access latency. In contrast to operation 878, operation 879 in some embodiments captures the situation where bidders (e.g., users 62*) select the content access latencies that they wish to bid on.

Turning now to FIG. 8B, in some implementations, operation 877 may include an operation 880 for providing at least the access to the specific content to the first one or more users following lapse of the first content access latency and providing at least the access to the specific content to the second one or more users following lapse of the second content access latency by further providing at least the access to the specific content to a third one or more users following lapse of a third content access latency, the lapse of the third content access latency following the particular point in time, and the third content access latency being greater than the first content access latency or the second content access latency. For instance, the content access releasing module 106* of the computing system 10* of FIG. 3A or 3B providing at least the access to the specific content 20 to the first one or more users (e.g., users 62a and 62d) following lapse of the first content access latency and providing at least the access to the specific content 20 to the second one or more users (e.g., user 62b) following lapse of the second content access latency by further providing (e.g., releasing) at least the access to the specific content 20 to a third one or more users (e.g., user 62c) following lapse of a third content access latency, the lapse of the third content access latency following the particular point in time (e.g., earliest point in time in which the specific content 20 can be made available), and the third content access latency being greater (e.g., greater time delay) than the first content access latency or the second content access latency.

As further illustrated in FIG. 8B, in some implementations, operation 880 may further include an operation 881 for providing at least the access to the specific content to the first one or more users following lapse of the first content access latency, providing at least the access to the specific content to the second one or more users following lapse of the second content access latency, and providing at least the access to the specific content to the third one or more users following lapse of the third content access latency, the first one or more users determined to have submitted one or more open bids that were determined to have indicated highest offer amount or amounts amongst the plurality of open bids, the second one or more users determined to have submitted one or more open bids that were determined to have indicated second highest offer amount or amounts amongst the plurality of open bids, and the third one or more users determined to have submitted one or more open bids that were determined to have indicated third highest offer amount or amounts amongst the plurality of open bids. For instance, the content access releasing module 106* of the computing system 10* of FIG. 3A or 3B providing (e.g., releasing) at least the access to the specific content 20 to the first one or more users (e.g., users 62a and 62d) following lapse of the first content access latency, providing (e.g., releasing) at least the access to the specific content 20 to the second one or more users (e.g., user 62b) following lapse of the second content access latency, and providing (e.g., releasing) at least the access to the specific content 20 to the third one or more users (e.g., user 62c) following lapse of the third content access latency, the first one or more users (e.g., users 62a and 62d) determined to have submitted one or more open bids (e.g., open bids 40a and 40d) that were determined or ascertained by the highest offer amount open bid ascertaining module 104* to have indicated highest offer amount or amounts amongst the plurality of open bids 40*, the second one or more users (e.g., user 62b) determined to have submitted one or more open bids (e.g., open bid 40b) that were determined or ascertained by the highest offer amount open bid ascertaining module 104* to have indicated second highest offer amount or amounts amongst the plurality of open bids 40*, and the third one or more users (e.g., user 62c) determined to have submitted one or more open bids (e.g., open bid 40c) that were determined or ascertained by the highest offer amount open bid ascertaining module 104* to have indicated third highest offer amount or amounts amongst the plurality of open bids.

In some cases, operation 880 may actually include or involve an operation 882 for providing at least the access to the specific content to the first one or more users following lapse of the first content access latency, providing at least the access to the specific content to the second one or more users following lapse of the second content access latency, and providing at least the access to the specific content to the third one or more users following lapse of the third content access latency, the first one or more users determined to have submitted one or more open bids that were determined to have indicated highest offer amount or amounts amongst a plurality of open bids for the first content access latency, the second one or more users determined to have submitted one or more open bids that were determined to have indicated highest offer amount or amounts amongst a plurality of open bids for the second content access latency, and the third one or more users determined to have submitted one or more open bids that were determined to have indicated highest offer amount or amounts amongst a plurality of open bids for the third content access latency. For instance, the content access releasing module 106* of the computing system 10* of FIG. 3A or 3B providing (e.g., releasing) at least the access to the specific content 20 to the first one or more users (e.g., users 62a and 62d of FIG. 1) following lapse of the first content access latency, providing (e.g., releasing) at least the access to the specific content 20 to the second one or more users (e.g., user 62b of FIG. 1) following lapse of the second content access latency, and providing (e.g., releasing) at least the access to the specific content 20 to the third one or more users (e.g., user 62c of FIG. 1) following lapse of the third content access latency, the first one or more users (e.g., users 62a and 62d) determined to have submitted one or more open bids (e.g., open bids 40a and 40d) that were determined or ascertained by the highest offer amount open bid ascertaining module 104* to have indicated highest offer amount or amounts amongst a plurality of open bids 40* for the first content access latency, the second one or more users (e.g., user 62b) determined to have submitted one or more open bids (e.g., open bid 40b) that were determined or ascertained by the highest offer amount open bid ascertaining module 104* to have indicated highest offer amount or amounts amongst a plurality of open bids 40* for the second content access latency, and the third one or more users (e.g., user 62c) determined to have submitted one or more open bids (e.g., open bid 40c) that were determined or ascertained by the highest offer amount open bid ascertaining module 104* to have indicated highest offer amount or amounts amongst a plurality of open bids 40* for the third content access latency.

Turning to FIG. 8C, in various implementations, operation 877 may include an operation 883 for providing at least the access to the specific content to the first one or more users following lapse of the first content access latency and providing at least the access to the specific content to the second one or more users by further providing to the second one or more users at least access to previous user information related to the first one or more users. For instance, the content access releasing module 106* including the previous user information access releasing module 418 (see FIG. 4C) of the computing system 10* of FIG. 3A or 3B providing (e.g., releasing) at least the access to the specific content 20 to the first one or more users (e.g., users 62a and 62d of FIG. 1) following lapse of the first content access latency and providing (e.g., releasing) at least the access to the specific content 20 to the second one or more users (e.g., user 62b of FIG. 1) when the previous user information access releasing module 418 further provides or releases to the second one or more users (e.g., user 62b) at least access to previous user information 22 related to the first one or more users (e.g., users 62a and 62d).

As further illustrated in FIG. 8C, in some implementations, operation 883 may further include an operation 884 for providing to the second one or more users at least the access to previous user information related to the first one or more users by providing to the second one or more users at least access to previous user information that identifies the first one or more users and/or the number of the first one or more users. For instance, the previous user information access releasing module 418 of the computing system 10* of FIG. 3A or 3B providing to the second one or more users (e.g., user 62b of FIG. 1) at least the access to previous user information 22 related to the first one or more users (e.g., users 62a and 62d of FIG. 1) by providing to the second one or more users (e.g., user 62b) at least access to previous user information 22 that identifies the first one or more users (e.g., users 62a and 62d) and/or the number of the first one or more users (62a and 62d).

In some implementations, operation 883 may include an operation 885 for providing to the second one or more users at least the access to previous user information related to the first one or more users by providing to the second one or more users previous user information that indicates when and/or how the first one or more users who have previously accessed the specific content actually accessed the specific content. For instance, the previous user information access releasing module 418 of the computing system 10* of FIG. 3A or 3B providing to the second one or more users (e.g., user 62b of FIG. 1) at least the access to previous user information 22 related to the first one or more users (e.g., users 62a and 62d of FIG. 1) by providing to the second one or more users (e.g., user 62b) previous user information 22 that indicates when and/or how (e.g., network or data transfer rate that was employed) the first one or more users (e.g., users 62a and 62d) who have previously accessed the specific content actually accessed the specific content 20.

Referring now to FIG. 8D, in some implementations, the highest offer content access providing operation 506 may include an operation 886 for providing at least the access to the specific content to the one or more of the plurality of users by further providing at least access to contextual information related to the specific content to the one or more of the plurality of users. For instance, the content access releasing module 106* including the contextual information access releasing module 420 (see FIG. 4C) of the computing system 10* of FIG. 3A or 3B providing at least the access to the specific content 20 to the one or more of the plurality of users 62* when the contextual information access releasing module 420 further provides or releases at least access to contextual information 24 (e.g., historical information, background information, movie trailers, and so forth) related to the specific content 20 to the one or more of the plurality of users 62*.

In the same or alternative implementations, the highest offer content access providing operation 506 may include an operation 887 for providing at least the access to the specific content to the one or more of the plurality of users in accordance, at least in part, with the determining by providing at least the access to the specific content to one or more client devices associated with the one or more of the plurality of users and providing one or more instructions to the one or more client devices that directs the one or more client devices to provide at least access to the specific content only after a specific amount of content access latency has lapsed. For instance, the content access releasing module 106* including the instructions releasing module 422 (see FIG. 4C) of the computing system 10* of FIG. 3A or 3B providing at least the access to the specific content 20 to the one or more of the plurality of users 62* in accordance, at least in part, with the determining of which of the one or more of the plurality of open bids 40* indicate at least the highest offer amount amongst the plurality of open bids 40* by providing at least the access to the specific content 20 to one or more client devices 60* associated with the one or more of the plurality of users 62* and providing or releasing, by the instructions releasing module 422, of one or more instructions to the one or more client devices 60* that directs the one or more client devices 60* to provide at least access to the specific content 20 only after a specific amount of content access latency has lapsed (e.g., the content access latency that was bid on through the one or more of the open bids 40*).

In some implementations, operation 887 may further include an operation 888 for providing at least the access to the specific content to the one or more client devices associated with the one or more of the plurality of users and providing the one or more instructions to the one or more client devices that directs the one or more client devices to provide at least the access to the specific content only after a specific amount of content access latency has lapsed by providing further access to the specific content to another one or more client devices associated with another one or more of the plurality of users and providing one or more instructions to the another one or more client devices that directs the another one or more client devices to provide at least access to the specific content only after another amount of content access latency has lapsed. For instance, the content access releasing module 106* including the instructions releasing module 422 of the computing system 10* of FIG. 3A or 3B providing at least the access to the specific content 20 to the one or more client devices 60* associated with the one or more of the plurality of users 62* and the instructions releasing module 422 providing or releasing the one or more instructions to the one or more client devices 60* that directs the one or more client devices 60* to provide at least the access to the specific content 20 only after a specific amount of content access latency has lapsed when content access releasing module 106* further provides the access to the specific content 20 to another one or more client devices 60* associated with another one or more of the plurality of users 62* and when the instructions releasing module 422 provides or releases one or more instructions to the another one or more client devices 60* that directs the another one or more client devices 60* to provide at least access to the specific content 20 only after another amount of content access latency has lapsed.

In the same or alternative implementations, the content access providing operation 506 may include an operation 889 for providing at least the access to the specific content to the one or more of the plurality of users by providing at least access to news content to the one or more of the plurality of users. For instance, the content access releasing module 106* of the computing system 10* of FIG. 3A or 3B providing at least the access to the specific content 20 to the one or more of the plurality of users 62* by providing (e.g., releasing) at least access to news content (e.g., market or financial news including stock market or commodity prices, regulatory news, crop reports, and so forth) to the one or more of the plurality of users 62*.

In the same or alternative implementations, the content access providing operation 506 may include an operation 890 for providing at least the access to the specific content to the one or more of the plurality of users by providing at least access to consumable media to the one or more of the plurality of users. For instance, the content access releasing module 106* of the computing system 10* of FIG. 3A or 3B providing at least the access to the specific content 20 to the one or more of the plurality of users 62* by providing at least access to consumable media (e.g., movies, audio recordings, recordings of sporting events, and so forth) to the one or more of the plurality of users 62*.

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

Those having skill in the art will recognize that the state of the art has progressed to the point where there is little distinct ion left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1-181. (canceled)

182. A system comprising:
an open bid obtaining module configured to obtain a plurality of open bids for one or more content access latencies, each of the plurality of open bids to be obtained indicating one or more offer amounts submitted by a plurality of users that the plurality of users are offering in exchange for being provided at least access to a specific content with the one or more content access latencies;
a highest offer amount open bid ascertaining module configured to ascertain which one or more of the plurality of open bids indicate at least the highest offer amount amongst the plurality of open bids; and
a content access releasing module configured to release at least access to the specific content to one or more of the plurality of users in accordance, at least in part, with the ascertainment, by the highest offer amount open bid ascertaining module, of which of the one or more of the plurality of open bids indicated at least the highest offer amount amongst the plurality of open bids.

183. (canceled)

184. The system of claim 182, wherein said open bid obtaining module configured to obtain a plurality of open bids for one or more content access latencies, each of the plurality of open bids to be obtained indicating one or more offer amounts submitted by a plurality of users that the plurality of users are offering in exchange for being provided at least access to a specific content with the one or more content access latencies comprises:
an open bid eliciting module configured to elicit the plurality of open bids from the plurality of users.

185. The system of claim 184, wherein said open bid eliciting module configured to elicit the plurality of open bids from the plurality of users comprises:
a bidding tag relaying module configured to relay to one or more client devices associated with the plurality of users at least one bidding tag that includes data that facilitates the one or more client devices to provide at least one interface for eliciting the plurality of open bids from the plurality of users.

186.-188. (canceled)

189. The system of claim 185 wherein said bidding tag relaying module configured to relay to one or more client devices associated with the plurality of users at least one bidding tag that includes data that facilitates the one or more client devices to provide at least one interface for eliciting the plurality of open bids from the plurality of users comprises:
a bidding tag relaying module configured to relay to the one or more client devices at least one bidding tag that includes data that facilitates the one or more client devices to provide at least the one interface, the bidding tag to be relayed identifying at least one content access latency available for bidding.

190. The system of claim 189, wherein said bidding tag relaying module configured to relay to the one or more client devices at least one bidding tag that includes data that facilitates the one or more client devices to provide at least the one interface, the bidding tag to be relayed identifying at least one content access latency available for bidding comprises:
a bidding tag relaying module configured to relay to the one or more client devices at least one bidding tag that identifies a plurality of different content access latencies available for bidding.

191. The system of claim 189, wherein said bidding tag relaying module configured to relay to the one or more client devices at least one bidding tag that includes data that facilitates the one or more client devices to provide at least the one interface, the bidding tag to be relayed identifying at least one content access latency available for bidding comprises:
a bidding tag relaying module configured to relay to the one or more client devices at least one bidding tag that identifies a range of content access latencies available for bidding.

192.-196. (canceled)

197. The system of claim 185 wherein said bidding tag relaying module configured to relay to one or more client devices associated with the plurality of users at least one bidding tag that includes data that facilitates the one or more client devices to provide at least one interface for eliciting the plurality of open bids from the plurality of users comprises:
a bidding tag relaying module configured to relay to the one or more client devices at least one bidding tag that includes data that facilitates the one or more client devices to provide at least one visual interface for eliciting the plurality of open bids.

198. The system of claim 197, wherein said bidding tag relaying module configured to relay to the one or more client devices at least one bidding tag that includes data that facilitates the one or more client devices to provide at least one visual interface for eliciting the plurality of open bids comprises:
a bidding tag relaying module configured to relay to the one or more client devices at least one bidding tag that includes data that facilitates the one or more client devices to provide at least one graphical user interface (GUI) for eliciting at least one open bid.

199.-203. (canceled)

204. The system of claim 198, wherein said bidding tag relaying module configured to relay to the one or more client devices at least one bidding tag that includes data that facilitates the one or more client devices to provide at least one graphical user interface (GUI) for eliciting at least one open bid comprises:
a bidding tag relaying module configured to relay to the one or more client devices at least one bidding tag that includes data that facilitates the one or more client devices to provide at least one GUI that includes at least one feature for electing at least one user elected amount of content access latency.

205. The system of claim 204, wherein said bidding tag relaying module configured to relay to the one or more client devices at least one bidding tag that includes data that facilitates the one or more client devices to provide at least one GUI that includes at least one feature for electing at least one user elected amount of content access latency comprises:
a bidding tag relaying module configured to relay to the one or more client devices at least one bidding tag that includes data that facilitates the one or more client devices to provide at least one GUI that includes at least one feature for selecting the at least one user elected amount of content access latency from a plurality of varying amounts of preset content access latencies.

206. (canceled)

207. The system of claim 204, wherein said bidding tag relaying module configured to relay to the one or more client devices at least one bidding tag that includes data that facilitates the one or more client devices to provide at least one GUI that includes at least one feature for electing at least one user elected amount of content access latency comprises:
a bidding tag relaying module configured to relay to the one or more client devices at least one bidding tag that includes data that facilitates the one or more client devices to provide at least one GUI that includes at least one feature for entering the at least one user elected amount of content access latency.

208. The system of claim 198, wherein said bidding tag relaying module configured to relay to the one or more client devices at least one bidding tag that includes data that facilitates the one or more client devices to provide at least one graphical user interface (GUI) for eliciting at least one open bid comprises:
a bidding tag relaying module configured to relay to the one or more client devices at least one bidding tag that includes data that facilitates the one or more client devices to provide at least one GUI that includes a first feature for electing at least one user elected fee amount and a second feature for electing at least one user elected amount of content access latency, the user elected fee amount and the user elected amount of content access latency for defining at least one open bid.

209. The system of claim 208, wherein said bidding tag relaying module configured to relay to the one or more client devices at least one bidding tag that includes data that facilitates the one or more client devices to provide at least one GUI that includes a first feature for electing at least one user elected fee amount and a second feature for electing at least one user elected amount of content access latency, the user elected fee amount and the user elected amount of content access latency for defining at least one open bid comprises:
a bidding tag relaying module configured to relay to the one or more client devices at least one bidding tag that includes data that facilitates the one or more client devices to provide at least one GUI that includes a first feature for entering the at least one user elected fee amount and a second feature for entering the at least one user elected amount of content access latency.

210.-221. (canceled)

222. The system of claim 198, wherein said bidding tag relaying module configured to relay to the one or more client devices at least one bidding tag that includes data that facilitates the one or more client devices to provide at least one graphical user interface (GUI) for eliciting at least one open bid comprises:
a bidding tag relaying module configured to relay to the one or more client devices at least one bidding tag that includes data that facilitates the one or more client devices to provide at least one GUI that provides access to previous consumer information related to one or more users who have previously accessed the specific content.

223. (canceled)

224. (canceled)

225. The system of claim 222, wherein said bidding tag relaying module configured to relay to the one or more client devices at least one bidding tag that includes data that facilitates the one or more client devices to provide at least one GUI that provides access to previous consumer information related to one or more users who have previously accessed the specific content comprises:
a bidding tag relaying module configured to relay to the one or more client devices at least one bidding tag that includes data that facilitates the one or more client devices to provide at least one GUI that provides access to previous consumer information that identifies the one or more users who have previously accessed the specific content and/or the number of one or more users who have previously accessed the specific content.

226. The system of claim 222, wherein said bidding tag relaying module configured to relay to the one or more client devices at least one bidding tag that includes data that facilitates the one or more client devices to provide at least one GUI that provides access to previous consumer information related to one or more users who have previously accessed the specific content comprises:
a bidding tag relaying module configured to relay to the one or more client devices at least one bidding tag that includes data that facilitates the one or more client devices to provide at least one GUI that provides access to previous consumer information that indicates when and/or how the one or more users who have previously accessed the specific content actually accessed the specific content.

227. The system of claim 198, wherein said bidding tag relaying module configured to relay to the one or more client devices at least one bidding tag that includes data that facilitates the one or more client devices to provide at least one graphical user interface (GUI) for eliciting at least one open bid comprises:
a bidding tag relaying module configured to relay to the one or more client devices at least one bidding tag that includes data that facilitates the one or more client devices to provide at least one GUI that includes a first feature for electing a first user elected fee amount for a first content access latency and a second feature for electing a second user elected fee amount for a second content access latency.

228. (canceled)

229. The system of claim 227, wherein said bidding tag relaying module configured to relay to the one or more client devices at least one bidding tag that includes data that facilitates the one or more client devices to provide at least one GUI that includes a first feature for electing a first user elected fee amount for a first content access latency and a second feature for electing a second user elected fee amount for a second content access latency comprises:
a bidding tag relaying module configured to relay to the one or more client devices at least one bidding tag that includes data that facilitates the one or more client devices to provide at least one GUI that includes the first feature for electing the first user elected fee amount for the first content access latency, the second feature for electing the second user elected fee amount for the second content access latency, and a third feature for electing a third user elected fee amount for a third content access latency.

230.-247. (canceled)

248. The system of claim 182, wherein said highest offer amount open bid ascertaining module configured to ascertain which one or more of the plurality of open bids indicate at least the highest offer amount amongst the plurality of open bids comprises:
a highest offer amount open bid ascertaining module configured to ascertain which one or more of a plurality of open bids for a specific content access latency indicate the highest offer amount or amounts amongst the plurality of open bids for the specific content access latency.

249. The system of claim 248, wherein said highest offer amount open bid ascertaining module configured to ascertain which one or more of a plurality of open bids for a specific content access latency indicate the highest offer amount or amounts amongst the plurality of open bids for the specific content access latency comprises:
a highest offer amount open bid ascertaining module configured to ascertain further which one or more of a plurality of open bids for a second content access latency indicate the highest offer amount or amounts amongst the plurality of open bids for the second content access latency, the specific content access latency being a first content access latency.

250. The system of claim 249, wherein said highest offer amount open bid ascertaining module configured to ascertain further which one or more of a plurality of open bids for a second content access latency indicate the highest offer amount or amounts amongst the plurality of open bids for the second content access latency, the specific content access latency being a first content access latency comprises:
a highest offer amount open bid ascertaining module configured to ascertain further which one or more of a plurality of open bids for a third content access latency indicate the highest offer amount or amounts amongst the plurality of open bids for the third content access latency.

251. (canceled)

252. The system of claim 182, wherein said highest offer amount open bid ascertaining module configured to ascertain which one or more of the plurality of open bids indicate at least the highest offer amount amongst the plurality of open bids comprises:
an open bid ranking module configured to rank the plurality of open bids from one or more open bids that indicate the highest offer amount from amongst the plurality of open bids to one or more open bids that indicate the lowest offer amount from amongst the plurality of open bids.

253. The system of claim 182, wherein said highest offer amount open bid ascertaining module configured to ascertain which one or more of the plurality of open bids indicate at least the highest offer amount amongst the plurality of open bids comprises:
a highest offer amount open bid ascertaining module configured to ascertain which of two or more of the plurality of open bids indicate the highest offer amount and ascertain which of the two or more of the plurality of open bids that were determined to indicate the highest offer amount were acquired first.

254. The system of claim 182, wherein said content access releasing module configured to release at least access to the specific content to one or more of the plurality of users in accordance, at least in part, with the ascertainment, by the highest offer amount open bid ascertaining module, of which of the one or more of the plurality of open bids indicated at least the highest offer amount amongst the plurality of open bids comprises:
a content access releasing module configured to release at least the access to the specific content to one or more client devices associated with the one or more of the plurality of users in accordance, at least in part, with the determining.

255. (canceled)

256. (canceled)

257. The system of claim 182, wherein said content access releasing module configured to release at least access to the specific content to one or more of the plurality of users in accordance, at least in part, with the ascertainment, by the highest offer amount open bid ascertaining module, of which of the one or more of the plurality of open bids indicated at least the highest offer amount amongst the plurality of open bids comprises:
a content access releasing module configured to release at least access to the specific content to a first one or more users following lapse of a first content access latency and release at least access to the specific content to a second one or more users following lapse of a second content access latency, the lapse of the first content access latency and the lapse of the second content access latency occurring following a particular point in time, and the first content access latency being less than the second content access latency.

258. The system of claim 257, wherein said content access releasing module configured to release at least access to the specific content to a first one or more users following lapse of a first content access latency and release at least access to the specific content to a second one or more users following lapse of a second content access latency, the lapse of the first content access latency and the lapse of the second content access latency occurring following a particular point in time, and the first content access latency being less than the second content access latency comprises:
a content access releasing module configured to release at least the access to the specific content to the first one or more users following lapse of the first content access latency and release at least the access to the specific content to the second one or more users following lapse of the second content access latency, the first one or more users determined to have submitted one or more open bids that were ascertained by the highest offer amount open bid ascertaining module to have indicated highest offer amount or amounts amongst the plurality of open bids and the second one or more users determined to have submitted one or more open bids that were ascertained by the highest offer amount open bid ascertaining module to have indicated second highest offer amount or amounts amongst the plurality of open bids.

259. The system of claim 257, wherein said content access releasing module configured to release at least access to the specific content to a first one or more users following lapse of a first content access latency and release at least access to the specific content to a second one or more users following lapse of a second content access latency, the lapse of the first content access latency and the lapse of the second content access latency occurring following a particular point in time, and the first content access latency being less than the second content access latency comprises:
a content access releasing module configured to release at least the access to the specific content to the first one or more users following lapse of the first content access latency and release at least the access to the specific content to the second one or more users following lapse of the second content access latency, the first one or more users determined to have submitted one or more open bids that were ascertained by the highest offer amount open bid ascertaining module to have indicated highest offer amount or amounts amongst a plurality of open bids for the first content access latency and the second one or more users ascertained by the highest offer amount open bid ascertaining module to have submitted one or more open bids that were determined to have indicated highest offer amount or amounts amongst a plurality of open bids for the second content access latency.

260. The system of claim 257, wherein said content access releasing module configured to release at least access to the specific content to a first one or more users following lapse of a first content access latency and release at least access to the specific content to a second one or more users following lapse of a second content access latency, the lapse of the first content access latency and the lapse of the second content access latency occurring following a particular point in time, and the first content access latency being less than the second content access latency comprises:
a content access releasing module configured to further release at least the access to the specific content to a third one or more users following lapse of a third content access latency, the lapse of the third content access latency following the particular point in time, and the third content access latency being greater than the first content access latency or the second content access latency.

261. The system of claim 260, wherein said content access releasing module configured to further release at least the access to the specific content to a third one or more users following lapse of a third content access latency, the lapse of the third content access latency following the particular point in time, and the third content access latency being greater than the first content access latency or the second content access latency comprises:
a content access releasing module configured to release at least the access to the specific content to the first one or more users following lapse of the first content access latency, release at least the access to the specific content to the second one or more users following lapse of the second content access latency, and release at least the access to the specific content to the third one or more users following lapse of the third content access latency, the first one or more users determined to have submitted one or more open bids that were ascertained by the highest offer amount open bid ascertaining module to have indicated highest offer amount or amounts amongst the plurality of open bids, the second one or more users determined to have submitted one or more open bids that were ascertained by the highest offer amount open bid ascertaining module to have indicated second highest offer amount or amounts amongst the plurality of open bids, and the third one or more users determined to have submitted one or more open bids that were ascertained by the highest offer amount open bid ascertaining module to have indicated third highest offer amount or amounts amongst the plurality of open bids.

262. The system of claim 260, wherein said content access releasing module configured to further release at least the access to the specific content to a third one or more users following lapse of a third content access latency, the lapse of the third content access latency following the particular point in time, and the third content access latency being greater than the first content access latency or the second content access latency comprises:
a content access releasing module configured to release at least the access to the specific content to the first one or more users following lapse of the first content access latency, release at least the access to the specific content to the second one or more users following lapse of the second content access latency, and release at least the access to the specific content to the third one or more users following lapse of the third content access latency, the first one or more users determined to have submitted one or more open bids that were ascertained by the highest offer amount open bid ascertaining module to have indicated highest offer amount or amounts amongst a plurality of open bids for the first content access latency, the second one or more users determined to have submitted one or more open bids that were ascertained by the highest offer amount open bid ascertaining module to have indicated highest offer amount or amounts amongst a plurality of open bids for the second content access latency, and the third one or more users determined to have submitted one or more open bids that were ascertained by the highest offer amount open bid ascertaining module to have indicated highest offer amount or amounts amongst a plurality of open bids for the third content access latency.

263. The system of claim 257, wherein said content access releasing module configured to release at least access to the specific content to a first one or more users following lapse of a first content access latency and release at least access to the specific content to a second one or more users following lapse of a second content access latency, the lapse of the first content access latency and the lapse of the second content access latency occurring following a particular point in time, and the first content access latency being less than the second content access latency comprises:
a previous user information access releasing module configured to release to the second one or more users at least access to previous user information related to the first one or more users.

264. The system of claim 263, wherein said previous user information access releasing module configured to release to the second one or more users at least access to previous user information related to the first one or more users comprises:
a previous user information access releasing module configured to release to the second one or more users at least access to previous user information that identifies the first one or more users and/or the number of the first one or more users.

265. The system of claim 263, wherein said previous user information access releasing module configured to release to the second one or more users at least access to previous user information related to the first one or more users comprises:
a previous user information access releasing module configured to release to the second one or more users previous user information that indicates when and/or how the first one or more users who have previously accessed the specific content actually accessed the specific content.

266. (canceled)

267. The system of claim 182, wherein said content access releasing module configured to release at least access to the specific content to one or more of the plurality of users in accordance, at least in part, with the ascertainment, by the highest offer amount open bid ascertaining module, of which of the one or more of the plurality of open bids indicated at least the highest offer amount amongst the plurality of open bids comprises:
a content access releasing module including an instructions releasing module configured to release at least the access to the specific content to the one or more of the plurality of users in accordance, at least in part, with the ascertaining by releasing at least the access to the specific content to one or more client devices associated with the one or more of the plurality of users and releasing, by the instructions releasing module, of one or more instructions to the one or more client devices that directs the one or more client devices to provide at least access to the specific content only after a specific amount of content access latency has lapsed.

268. The system of claim 267, wherein said content access releasing module including an instructions releasing module configured to release at least the access to the specific content to the one or more of the plurality of users in accordance, at least in part, with the ascertaining by releasing at least the access to the specific content to one or more client devices associated with the one or more of the plurality of users and releasing, by the instructions releasing module, of one or more instructions to the one or more client devices that directs the one or more client devices to provide at least access to the specific content only after a specific amount of content access latency has lapsed comprises:
a content access releasing module including an instructions releasing module configured to release further the access to the specific content to another one or more client devices associated with another one or more of the plurality of users and the instructions releasing module configured to release one or more instructions to the another one or more client devices that directs the another one or more client devices to provide at least access to the specific content only after another amount of content access latency has lapsed.

269. The system of claim 182, wherein said content access releasing module configured to release at least access to the specific content to one or more of the plurality of users in accordance, at least in part, with the ascertainment, by the highest offer amount open bid ascertaining module, of which of the one or more of the plurality of open bids indicated at least the highest offer amount amongst the plurality of open bids comprises:
a content access releasing module configured to release at least access to news content to the one or more of the plurality of users.

270. The system of claim 182, wherein said content access releasing module configured to release at least access to the specific content to one or more of the plurality of users in accordance, at least in part, with the ascertainment, by the highest offer amount open bid ascertaining module, of which of the one or more of the plurality of open bids indicated at least the highest offer amount amongst the plurality of open bids comprises:
a content access releasing module configured to release at least access to consumable media to the one or more of the plurality of users.

271. An article of manufacture, comprising:
a non-transitory storage medium bearing:
one or more instructions for obtaining a plurality of open bids for one or more content access latencies, each of the plurality of open bids to be obtained indicating one or more offer amounts submitted by a plurality of users that the plurality of users are offering in exchange for being provided at least access to a specific content with the one or more content access latencies;
one or more instructions for ascertaining which one or more of the plurality of open bids indicate at least the highest offer amount amongst the plurality of open bids; and
one or more instructions for releasing at least access to the specific content to one or more of the plurality of users in accordance, at least in part, with the ascertaining of which of the one or more of the plurality of open bids indicated at least the highest offer amount amongst the plurality of open bids.

272. A server system, comprising:
a open bid obtaining module configured to obtain a plurality of open bids for one or more content access latencies, each of the plurality of open bids to be obtained indicating one or more offer amounts submitted by a plurality of users that the plurality of users are offering in exchange for being provided at least access to a specific content with the one or more content access latencies;
a highest offer amount open bid ascertaining module configured to ascertain which one or more of the plurality of open bids indicate at least the highest offer amount amongst the plurality of open bids;
a content access releasing module configured to release at least access to the specific content to one or more of the plurality of users in accordance, at least in part, with the ascertainment, by the highest offer amount open bid ascertaining module, of which of the one or more of the plurality of open bids indicated at least the highest offer amount amongst the plurality of open bids; and
a network interface.
